(19) United States
(12) Patent Application Publication
(10) Pub. No.: US 2026/0362334 A1
(43) Pub. Date: Nov. 12, 2026

(54) ENERGY-SAVING METHOD AND COMMUNICATION APPARATUS APPLIED TO MULTI-LINK COMMUNICATION

(71) Applicant: HUAWEI TECHNOLOGIES CO., LTD., Shenzhen (CN)

(72) Inventor: Yuchen Guo, Shenzhen (CN)

(21) Appl. No.: 19/739,548

(22) Filed: Jul. 13, 2026

Related U.S. Application Data
(63) Continuation of application No. 17/902,020, filed on Sep. 2, 2022, now Pat. No. 12,726,904.
Application No. 17/902,020 is a continuation of application No. PCT/CN2021/079226, filed on Mar. 5, 2021.

(30) Foreign Application Priority Data
Mar. 6, 2020 (CN) 202010151289.2

(51) Int. Cl. H04W 52/02; H04W 76/15

(52) U.S. Cl. CPC H04W 52/0235; H04W 76/15

(57) ABSTRACT

A communication mode switching method includes receiving, by a second device, a first message from a first device. The first message is used to notify the second device that the first device is switching a communication mode. The switching the communication mode includes switching from a first communication mode to a second communication mode, or switching from the second communication mode to the first communication mode. The communication mode switching method also includes determining, by the second device, the communication mode to which the first device switches. The first communication mode includes a first configuration. The second communication mode includes the first configuration and a second configuration. Under the first configuration, the first device can perform communication on N links, under the second configuration, the first device can perform communication on M links, and N is greater than M.

### CROSS-REFERENCE TO RELATED APPLICATIONS

This application is a continuation of U.S. patent application Ser. No. 17/902,020, filed on Sep. 2, 2022, which is a continuation of International Application No. PCT/CN2021/079226, filed on Mar. 5, 2021. The International Application claims priority to Chinese Patent Application No. 202010151289.2, filed on Mar. 6, 2020. All of the afore-mentioned patent applications are hereby incorporated by reference in their entireties.

### TECHNICAL FIELD

This application relates to the wireless communication field, and more specifically, to an power save method and a communication apparatus that are applied to multi-link communication.

### BACKGROUND

With development of wireless technologies, increasingly more wireless devices support multi-link communication. For example, a device may simultaneously perform communication on a plurality of frequency bands, for example, simultaneously perform communication on frequency bands of 2.4 gigahertz (GHz), 5 GHZ, and 6 GHz; or a device may simultaneously perform communication on different channels in a same frequency band. This can improve a communication rate between devices.

In multi-link communication, a communication rate can be improved by using more antennas and more radio frequency (RF) chains (RF chains). However, more antennas and more radio frequency chains may cause higher energy consumption.

Therefore, how to achieve a balance between a high rate and low power consumption is an urgent problem to be resolved.

### SUMMARY

This application provides an power save method and a communication apparatus that are applied to multi-link communication, to achieve a balance between a high rate and low power consumption.

According to a first aspect, a communication mode switching method is provided. The method may be performed by a first device, or may be performed by a chip, a circuit, or a processing system configured in the first device. This is not limited in this application. For example, due to a difference in an integration level, the first device may be a device, or may be a part of a device, for example, a chip system or a processing system. This is not limited in this application. The first device may be, for example, a multi-link device such as a multi-link station device.

The method may include: The first device sends a first message to a second device, where the first message is used to notify the second device that the first device switches a communication mode, and the switching a communication mode includes: switching from a first communication mode to a second communication mode, or switching from the second communication mode to the first communication mode; and the first device switches from the first communication mode to the second communication mode, or the first device switches from the second communication mode to the first communication mode, where the first communication mode includes a first configuration, the second communication mode includes the first configuration and a second configuration, under the first configuration, the first device can perform communication on N links, under the second configuration, the first device can perform communication on M links, M is an integer greater than 1 or equal to 1, N is an integer greater than 2 or equal to 2, and N is greater than M. Optionally, that the first message is used to notify the second device that the first device switches a communication mode includes: The first message is used to notify the second device that the first device switches the communication mode; or the first message is used to request to the second device that the first device switches the communication mode.

Optionally, that the first communication mode includes a first configuration indicates that after the first device switches from the second communication mode to the first communication mode, the first device may perform communication by using the first configuration.

Optionally, that the second communication mode includes the first configuration and a second configuration indicates that after the first device switches from the first communication mode to the second communication mode, the first device may perform communication by using the first configuration, or may perform communication by using the second configuration.

Based on the foregoing technical solution, the first device serving as the multi-link device may dynamically switch between different communication modes. For example, the first device may dynamically switch between different communication modes based on different communication environments, for example, based on a communication requirement of service data. In addition, the first communication mode and the second communication mode correspond to respective configuration information. For example, the first communication mode includes the first configuration, and the second communication mode includes the first configuration and the second configuration. Therefore, after the communication mode is switched, the corresponding configuration may be used for communication, and each station of the first device does not need to send an operating mode indication (OMI) to change an operating parameter on an operating link of the station. Therefore, this can not only achieve a balance between a high rate and low power consumption, but also can reduce signaling overheads and a waste of resources. With reference to the first aspect, in some embodiments of the first aspect, the first device switches the communication mode after receiving a second message from the second device, where the second message is a response message or an acknowledgment message for the first message.

In an example, the first device switches the communication mode after receiving the response message for the first message. In other words, the first device may switch the communication mode after receiving the response message from the second device for the first message, or after determining that the second device agrees on switching of the communication mode.

For still another example, the first device switches the communication mode after receiving the acknowledgment message for the first message. In other words, the first device may switch the communication mode after receiving the acknowledgment message for the first message from the second device, or after determining that the second device successfully receives the first message.

Based on the foregoing technical solution, the first device switches the communication mode when determining that the second device successfully receives the first message, or when determining that the second device agrees the first device to switch the communication mode. In this manner, the first device does not incorrectly switch the communication mode because the second device does not receive the first message or does not agree on switching of the communication mode. Therefore, this can avoid degradation of communication performance and a waste of resources caused by incorrect switching of the communication mode.

With reference to the first aspect, in some implementations of the first aspect, when the first device switches from the first communication mode to the second communication mode, the first device performs communication by using the second configuration; or the first device switches between the first configuration and the second configuration for communication.

For example, when the first device is in the second communication mode, the first device may perform communication by using the second configuration.

Based on this solution, the first communication mode and the second communication mode correspond to respective configuration information. For example, the first communication mode includes the first configuration, and the second communication mode includes the second configuration. Therefore, after the communication mode is switched, the corresponding configuration may be used for communication, and each station of the first device does not need to send an operating mode indication (OMI) to change an operating parameter on an operating link of the station. Therefore, this can not only achieve a balance between a high rate and low power consumption, but also can reduce signaling overheads and a waste of resources.

For still another example, when the first device is in the second communication mode, the first device may switch between the first configuration and the second configuration. A quantity of links enabled under the second configuration is less than a quantity of links enabled under the first configuration. For example, the second configuration enables a single link for communication, and the second configuration enables a plurality of links for communication.

Based on this solution, after entering the second communication mode, the multi-link device (for example, the first device) may dynamically switch between a plurality of configurations (for example, the second configuration and the first configuration). This can achieve a balance between a high rate and low power consumption.

With reference to the first aspect, in some implementations of the first aspect, when the first device switches from the first communication mode to the second communication mode, the first device performs communication by using the second configuration; and the method further includes: After receiving a radio frame from the second device, the first device switches to the first configuration, and transmits data to the second device by using the first configuration.

Optionally, the method further includes: The first device sends a third message to the second device, where the third message indicates the first device to transmit the data to the second device by using the first configuration.

Based on the foregoing technical solution, the first device may switch from performing communication by using the second configuration to performing communication by using the first configuration. In addition, after entering the second communication mode (or referred to as a multi-link power save mode), the multi-link device (for example, the first device) may dynamically switch between the first configuration and the second configuration. This can achieve a balance between a high rate and low power consumption.

With reference to the first aspect, in some implementations of the first aspect, when the first device switches from the first communication mode to the second communication mode, the first device performs communication by using the second configuration; and the method further includes: The first device receives information about a third configuration from the second device; and the first device switches to the third configuration based on the information about the third configuration, and transmits data to the second device by using the third configuration.

Optionally, the method further includes: The first device sends a third message to the second device, where the third message indicates the first device to transmit the data to the second device by using the third configuration.

Based on the foregoing technical solution, the first device may switch from performing communication by using the second configuration to performing communication by using the third configuration. In addition, the second device may recommend, to the first device based on an actual communication requirement, a configuration parameter, namely, the third configuration, for transmitting a data frame. This can improve data transmission performance.

With reference to the first aspect, in some implementations of the first aspect, when the first device switches from the first communication mode to the second communication mode, the first device performs communication by using the second configuration; and the method further includes: The first device receives information about a third configuration from the second device; and the first device switches to a fourth configuration based on the information about the third configuration, and transmits data to the second device by using the fourth configuration, where the fourth configuration is determined based on the third configuration.

Optionally, the method further includes: The first device sends a third message to the second device, where the third message includes information about the fourth configuration, and the third message indicates the first device to transmit the data to the second device by using the fourth configuration.

Based on the foregoing technical solution, the first device may switch from performing communication by using the second configuration to performing communication by using the fourth configuration. In addition, the first device may adjust a parameter configuration of the first device based on a configuration of a data frame subsequently sent by the second device, to avoid using excessive links, spatial streams, and bandwidth. This reduces an energy waste.

With reference to the first aspect, in some implementations of the first aspect, the method further includes: The first device performs communication by using the second configuration after the data transmission ends.

Optionally, the first device may perform communication by using the second configuration after data transmission on all links used for transmitting the data is completed; or the first device may perform communication by using the second configuration after data transmission on some links used for transmitting the data is completed.

Based on the foregoing technical solution, after the data transmission ends, the first device continues to restore the second configuration for communication, to reduce an energy waste and save energy.

With reference to the first aspect, in some implementations of the first aspect, the data transmission includes: The first device receives a data frame from the second device on T links, where T is an integer greater than 1 or equal to 1; and the method further includes: The data frame received by the first device on each of the T links includes a third field, and the first device determines, based on the third field on each of the T links, whether the data transmission ends; or the data frame includes a fourth field, the fourth field is used to carry control information, and the first device determines, based on the fourth field, whether the data transmission ends.

For example, the third field is a more data field. A more data field in a data frame on a link indicates whether data transmission on the corresponding link ends. The first device may determine, based on a more data field on each link used for data transmission, whether the data transmission ends.

For example, the fourth field is a multi-link more data field. The multi-link more data field may indicate whether data transmission on the T links ends, and the first device may determine, based on the multi-link more data field, whether the data transmission ends.

With reference to the first aspect, in some implementations of the first aspect, the method further includes: The first device sends indication information to a station of the second device, where the indication information includes information about the first configuration or information about the second configuration, and the indication information indicates configuration information of each station on one or more links of the first device.

Based on the foregoing technical solution, configuration information of a plurality of links may be indicated by using one piece of signaling. This reduces signaling overheads.

With reference to the first aspect, in some implementations of the first aspect, the first message includes one or more of the following: first information, information about a communication link, and second information; the first information indicates whether the first device switches from the first communication mode to the second communication mode; the information about the communication link indicates a communication link obtained after the communication mode is switched; and the second information indicates whether the first device can switch between the first configuration and the second configuration when the first device switches from the first communication mode to the second communication mode.

For example, the first information indicates whether the first device switches from the first communication mode to the second communication mode. Alternatively, the first information may indicate that a communication mode of the first device is the first communication mode or the second communication mode, the first device switches the communication mode to the second communication mode, or the first device switches the communication mode to the first communication mode.

With reference to the first aspect, in some implementations of the first aspect, the information about the first configuration or the information about the second configuration includes one or more pieces of the following information: an identifier of a link, a number of spatial streams of the link, bandwidth of the link, whether to support uplink multi-user transmission, and whether to support an extended-range transmission mode.

In an example, the information about the first configuration or the information about the second configuration may include the identifier of the link. Therefore, the first device may communicate with the second device on the determined link. This improves communication performance.

For still another example, the information about the first configuration or the information about the second configuration may include the number of spatial streams of the link and/or the bandwidth of the link. Therefore, when the first device communicates with the second device, communication may be performed based on a number of spatial streams of an appropriate link and/or bandwidth of the link. This improves communication performance.

According to a second aspect, a communication mode switching method is provided. The method may be performed by a second device, or may be performed by a chip, a circuit, or a processing system configured in the second device. This is not limited in this application. For example, based on a difference in an integration level, the second device may be a device, or may be a processing circuit or a processing system in a device. This is not limited in this application. The second device may be, for example, a multi-link device such as a multi-link access point device.

The method may include: The second device receives a first message from a first device, where the first message is used to notify the second device that the first device switches a communication mode, and the switching a communication mode includes: switching from a first communication mode to a second communication mode, or switching from the second communication mode to the first communication mode; and the second device determines a communication mode to which the first device switches, where the first communication mode includes a first configuration, the second communication mode includes the first configuration and a second configuration, under the first configuration, the first device can perform communication on N links, under the second configuration, the first device can perform communication on M links, M is an integer greater than 1 or equal to 1, N is an integer greater than 2 or equal to 2, and N is greater than M.

Optionally, the method further includes: The second device communicates with the first device by using a transmission parameter supported by the communication mode to which the first device switches.

Based on the foregoing technical solution, as a multi-link device, the first device may dynamically switch between different communication modes. The first device may notify the second device of the communication mode to which the first device switches. In this way, the second device may communicate with the first device based on the transmission parameter supported by the communication mode to which the first device switches. Therefore, this can not only achieve a balance between a high rate and low power consumption, but also can ensure communication performance between the first device and the second device.

With reference to the second aspect, in some implementations of the second aspect, the second device sends a second message to the first device, where the second message is a response message or an acknowledgment message for the first message.

With reference to the second aspect, in some implementations of the second aspect, the second device determines that the communication mode to which the first device switches is the second communication mode; the second device sends a radio frame to the first device by using a first parameter, where the first parameter is a parameter supported by the second configuration; and the second device receives a third message from the first device, and transmits data to the first device by using a second parameter, where the second parameter is a parameter supported by the first configuration, and the third message indicates the second device to transmit the data by using the first configuration.

With reference to the second aspect, in some implementations of the second aspect, the second device determines that the communication mode to which the first device switches is the second communication mode; the second device sends information about a third configuration to the first device by using a first parameter, where the first parameter is a parameter supported by the second configuration; and the second device receives a third message from the first device, and transmits data to the first device by using a third parameter, where the third parameter is a parameter supported by the third configuration, and the third message indicates the second device to transmit the data by using the third configuration.

With reference to the second aspect, in some implementations of the second aspect, the second device determines that the communication mode to which the first device switches is the second communication mode; the second device sends information about a third configuration to the first device by using a first parameter, where the first parameter is a parameter supported by the second configuration; and the second device receives a third message from the first device, where the third message includes information about a fourth configuration, and the second device transmits data to the first device by using a fourth parameter, where the fourth parameter is a parameter supported by the fourth configuration, and the fourth configuration is determined based on the third configuration.

With reference to the second aspect, in some implementations of the second aspect, the method further includes: The second device receives indication information from the first device, where the indication information includes information about the first configuration or information about the second configuration; and the second device determines configuration information of each station on one or more links of the first device based on the indication information.

With reference to the second aspect, in some implementations of the second aspect, the first message includes one or more of the following: first information, information about a communication link, and second information; the first information indicates whether the first device switches from the first communication mode to the second communication mode; the information about the communication link indicates a communication link obtained after the communication mode is switched; and the second information indicates whether the first device can switch between the first configuration and the second configuration when the first device is in the second communication mode.

With reference to the second aspect, in some implementations of the second aspect, the information about the first configuration or the information about the second configuration includes one or more pieces of the following information: an identifier of a link, a number of spatial streams of the link, bandwidth of the link, whether to support uplink multi-user transmission, and whether to support an extended-range transmission mode.

According to a third aspect, a configuration indication method applied to multi-link communication is provided, to flexibly configure a link or a spatial stream, and the method is applied to the multi-link communication to reduce energy consumption. The method may be performed by a first device, or may be performed by a chip or a circuit configured in the first device. This is not limited in this application. For example, due to a difference in an integration level, the first device may be a device, or may be a part of a device, for example, a chip system or a processing system. This is not limited in this application. The first device may be, for example, a multi-link device such as a multi-link station device.

The method may include: The first device sends a configuration frame to a second device, where the configuration frame carries fifth configuration information, and the configuration frame indicates operating mode information of a plurality of links; and the first device receives an acknowledgment frame from the second device, where the acknowledgment frame is an acknowledgment frame for the configuration frame.

According to a fourth aspect, a configuration indication method applied to multi-link communication is provided, to flexibly configure a link or a spatial stream, and the method is applied to the multi-link communication to reduce energy consumption. The method may be performed by a second device, or may be performed by a chip or a circuit configured in the second device. This is not limited in this application. For example, based on a difference in an integration level, the second device may be a device, or may be a processing circuit or a processing system in a device. This is not limited in this application. The second device may be, for example, a multi-link device such as a multi-link access point device.

The method may include: The second device receives a configuration frame from a first device, where the configuration frame carries fifth configuration information, and the configuration frame indicates operating mode information of a plurality of links; and the second device sends an acknowledgment frame for the configuration frame to the first device, and transmits data to the first device by using a fifth parameter, where the fifth parameter is a parameter supported by the fifth configuration information.

Based on the foregoing technical solution, the multi-link device (for example, the first device) may flexibly change a radio frequency chain configuration of the multi-link device based on a requirement. For example, the first device may select a relatively optimal configuration or an optimal configuration, namely, the fifth configuration, and then send the fifth configuration information to the second device. Therefore, a radio frequency chain resource can be flexibly configured, a radio frequency chain can be properly used, and resource utilization can be improved.

With reference to the third aspect, in some implementations of the third aspect, the method further includes: After receiving the acknowledgment frame, the first device transmits data to the second device by using a fifth parameter, where the fifth parameter is a parameter supported by the fifth configuration information.

With reference to the third aspect or the fourth aspect, in some implementations, the operating mode information includes a number of spatial streams of a link.

Optionally, the operating mode information may further include bandwidth of the link, whether to support uplink multi-user transmission, and whether to support an extended-range transmission mode.

Based on the foregoing technical solution, the multi-link device (for example, the first device) may flexibly select the number of spatial streams of the link based on a requirement. In addition, information about the operating mode information is notified to the second device, for example, spatial streams of links of the second device are notified, or bandwidth of the links may be further notified. In this way, the second device can perform communication based on the determined communication parameter.

With reference to the third aspect or the fourth aspect, in some implementations, a frame structure of the fifth configuration information includes a spatial stream SS allocation field and a link identifier ID field, and the SS allocation field is used to carry allocation information of a spatial stream.

The SS allocation field is used to carry the allocation information of the spatial stream. In other words, the SS allocation field may carry allocation information of all spatial streams allocated to all links.

The link ID field may carry identification information of the link, that is, indicate the links to which the spatial streams are allocated.

Based on the foregoing technical solution, information about the link allocated to the spatial stream can be learned.

With reference to the third aspect or the fourth aspect, in some implementations, a frame structure of the fifth configuration information includes an SS allocation field and a link bitmap field, and the SS allocation field is used to carry allocation information of a spatial stream.

The SS allocation field is used to carry the allocation information of the spatial stream. In other words, the SS allocation field may carry allocation information of all spatial streams allocated to all links.

The link bitmap field may indicate the links to which the spatial streams are allocated.

Based on the foregoing technical solution, the links to which the spatial streams are allocated can be learned by using a bitmap.

With reference to the third aspect or the fourth aspect, in some implementations, a frame structure of the fifth configuration information includes a link ID field and a number of spatial streams NSS field, and the link ID field and the NSS field respectively indicate an identifier of a link and a number of allocated spatial streams.

According to a fifth aspect, a communication apparatus is provided, configured to perform the method in any possible implementation of the foregoing aspects. The apparatus includes a unit configured to perform the method in any possible implementation of the foregoing aspects.

According to a sixth aspect, another communication apparatus is provided, including a processor. The processor is coupled to a memory, and may be configured to execute instructions in the memory, to implement the method in any possible implementation of the first aspect to the fourth aspect. The memory may be an on-chip storage unit inside the processor, or may be an off-chip storage unit that is coupled to the memory and that is located outside the processor. In a possible implementation, the apparatus further includes a memory. In a possible implementation, the apparatus further includes a communication interface, and the processor is coupled to the communication interface.

In a possible implementation, the communication apparatus may be a first device (for example, a multi-link device such as a multi-link station device), may be a chip, a circuit, or a processing system configured in the first device, or may be a device including the first device.

In still another possible implementation, the communication apparatus may be a second device (for example, a multi-link device such as a multi-link access point device), may be a chip, a circuit, or a processing system configured in the second device, or may be a device including the second device.

In an implementation, the apparatus is a first device or a device including the first device. When the apparatus is the first device or the device including the first device, the communication interface may be a transceiver or an input/output interface. Optionally, the transceiver may be a transceiver circuit.

In another implementation, the apparatus is a chip configured in a first device. When the apparatus is the chip configured in the first device, the communication interface may be an input/output interface, an interface circuit, an output circuit, an input circuit, a pin, a related circuit, or the like. The processor may also be embodied as a processing circuit or a logic circuit.

In still another implementation, the apparatus is a second device or a device including the second device. When the apparatus is the second device or the device including the second device, the communication interface may be a transceiver or an input/output interface. Optionally, the transceiver may be a transceiver circuit.

In yet another implementation, the apparatus is a chip configured in a second device. When the apparatus is the chip configured in the second device, the communication interface may be an input/output interface, an interface circuit, an output circuit, an input circuit, a pin, a related circuit, or the like. The processor may also be embodied as a processing circuit or a logic circuit.

According to a seventh aspect, a computer-readable storage medium is provided. The computer readable-storage medium stores a computer program, and when the computer program is executed by a communication apparatus, the communication apparatus is enabled to implement the method in any possible implementation of the foregoing aspects.

According to an eighth aspect, a computer program product including instructions is provided. When the instructions are executed by a computer, a communication apparatus is enabled to implement the method in any possible implementation of the foregoing aspects.

According to a ninth aspect, a communication system is provided, including the foregoing first device and the foregoing second device.

### BRIEF DESCRIPTION OF DRAWINGS

FIG. 1 is a schematic diagram of a communication system applicable to an embodiment of this application;

FIG. 2 is a schematic diagram of multi-link communication;

FIG. 3 is a schematic block diagram of a communication mode switching method according to an embodiment of this application;

FIG. 4 and FIG. 5 are schematic diagrams of frame structures of a communication mode switching method applicable to an embodiment of this application;

FIG. 6 is a schematic interaction diagram of a communication mode switching method applicable to an embodiment of this application;

FIG. 7 is a schematic interaction diagram of a communication mode switching method applicable to still another embodiment of this application;

FIG. 8 and FIG. 9 are schematic diagrams of frame structures of a communication mode switching method applicable to an embodiment of this application;

FIG. 10 is a schematic interaction diagram of a communication mode switching method applicable to another embodiment of this application;

FIG. 11 is a schematic interaction diagram of a communication mode switching method applicable to yet another embodiment of this application;

FIG. 12 is a schematic diagram of a frame structure of a communication mode switching method applicable to an embodiment of this application;

FIG. 13 is a schematic diagram of a frame structure of a configuration frame applicable to an embodiment of this application;

FIG. 14 is a schematic diagram of still another frame structure of a configuration frame applicable to an embodiment of this application;

FIG. 15 is a schematic diagram of an SS allocation field applicable to an embodiment of this application;

FIG. 16 is a schematic diagram of another frame structure of a configuration frame applicable to an embodiment of this application;

FIG. 17 is a schematic block diagram of a communication apparatus according to an embodiment of this application;

FIG. 18 is a schematic block diagram of still another communication apparatus according to an embodiment of this application;

FIG. 19 is a schematic block diagram of a first device according to an embodiment of this application; and

FIG. 20 is a schematic block diagram of a second device according to an embodiment of this application.

### DESCRIPTION OF EMBODIMENTS

The following describes technical solutions of this application with reference to accompanying drawings.

Embodiments of this application provide a communication method applied to a wireless communication system, to reduce power consumption of a multi-link device. The wireless communication system may be a wireless local area network or a cellular network. The method may be implemented by a communication device in the wireless communication system or a chip or a processor in the communication device. The communication device may be a wireless communication device, for example, referred to as a multi-link device (MLD), that supports parallel transmission on a plurality of links. Compared with a device that supports only single-link transmission, the multi-link device has higher transmission efficiency and a higher throughput.

The multi-link device includes one or more affiliated stations (STA) (affiliated STAs), and the affiliated STA may work on one or more links. The affiliated station may be an access point (AP) station or a non-access point station (non-AP STA). For example, one multi-link device includes a plurality of affiliated STAs, and one affiliated STA separately works on one of a plurality of links. Another multi-link device includes one or more affiliated STAs, where one affiliated STA may work on one link or may switch to work on a plurality of links. For ease of description, “a multi-link device includes an affiliated STA” is briefly described as “a multi-link device includes a STA” in embodiments of this application. For ease of description, in this application, a multi-link device whose affiliated station is an AP may be referred to as a multi-link AP, a multi-link AP device, or a multi-link access point device; and a multi-link device whose affiliated station is a non-AP STA may be referred to as a multi-link STA, a multi-link STA device, or a multi-link station device.

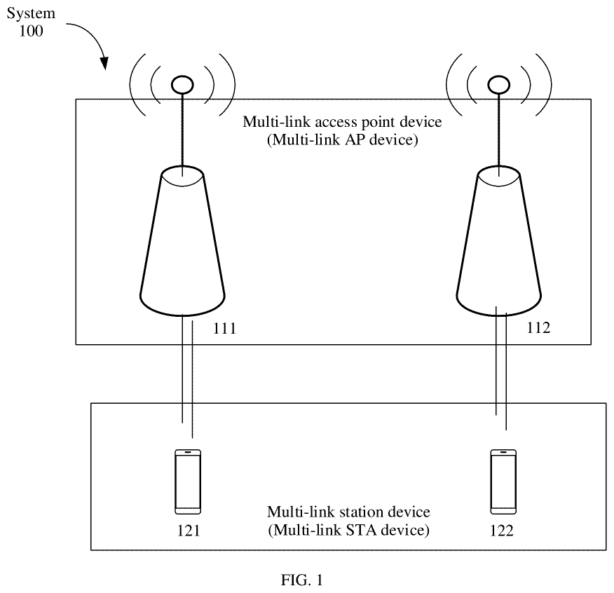

For ease of understanding of embodiments of this application, a communication system applicable to embodiments of this application is first described in detail with reference to FIG. 1.

FIG. 1 is another schematic diagram of a wireless communication system 100 applicable to an embodiment of this application. As shown in FIG. 1, the technical solution in this embodiment of this application may be applied to a wireless local area network, and the wireless communication system 100 may include at least one multi-link device. The multi-link device may be a multi-link access point device, or may be a multi-link station device. If being the multi-link access point device, the device may include one or more APs. If being the multi-link station device, the device may include one or more non-access point stations (non-AP STAs). The one or more non-AP STAs in the station device may communicate with the one or more APs in the access point device after an association relationship is established between the one or more non-AP STAs and the one or more APs.

For example, the wireless communication system 100 shown in FIG. 1 may include at least one multi-link access point device (AP MLD) and at least one multi-link station device (or referred to as a multi-link non-access point device (non-AP MLD)). The multi-link access point device may include, for example, an AP 111 and an AP 112, and the multi-link station device may include, for example, a STA 121 and a STA 122. The AP 111 may communicate with the STA 121. For example, the AP 111 communicates with the STA 121 after an association relationship is established between the AP 111 and the STA 121. The AP 112 may communicate with the STA 122. For example, the AP 112 communicates with the STA 122 after an association relationship is established between the AP 112 and the STA 122.

In this embodiment of this application, a first device may be, for example, the multi-link station device, and may include, for example, the STA 121 and the STA 122. A second device may be, for example, the multi-link access point device, and may include, for example, the access point device 111 and the access point device 112.

It should be understood that the foregoing communication system applicable to this application described with reference to FIG. 1 is merely an example for description, and the communication system applicable to this application is not limited thereto. For example, a quantity of APs and a quantity of STAs included in the communication system may alternatively be another quantity.

The multi-link device may be an apparatus having a wireless communication function, and may implement wireless communication in compliance with the 802.11 series protocols, for example, support an extremely high throughput (EHT) station, or support 802.11be or be compatible with 802.11be. The multi-link device may further be compatible with and support another protocol, for example, 802.11a/b/g/n/an, or the like. For example, the multi-link device may be a device, or may be a chip, a processing system, or the like installed on the device. The device on which the chip or the processing system is installed may implement methods and functions in embodiments of this application under control of the chip or the processing system.

The multi-link STA device in embodiments of this application may be a device having a wireless transceiver function, for example, may support the 802.11 series protocols, and may communicate with the multi-link AP, another multi-link STA, or a single-link device. For example, the multi-link STA is any user communication device that allows a user to communicate with an AP and then with the WLAN. The multi-link STA device is, for example, user equipment (UE), a mobile station (MS), a mobile terminal (MT), a STA, an access terminal, a subscriber unit, a subscriber station, a mobile station, a remote station, a remote terminal, a mobile device, a user terminal, a terminal, a wireless communication device, a user agent, a user apparatus, or the like.

The multi-link STA in embodiments of this application may further be a device that provides a user with voice/data connectivity, for example, a hand-held device or vehicle-mounted device having a wireless connection function. For example, the multi-link STA is a mobile phone, a tablet computer, a notebook computer, a palmtop computer, a mobile Internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a hand-held device having a wireless communication function, a computing device or another processing device connected to a wireless modem, a vehicle-mounted device, a wearable device, a terminal device in a 5G network, or a terminal device in a future evolved public land mobile network (PLMN). This is not limited in embodiments of this application.

As an example rather than a limitation, in embodiments of this application, the multi-link STA device may alternatively be a wearable device. The wearable device may also be referred to as a wearable intelligent device, and is a general term of a wearable device that is intelligently designed and developed for daily wear by using a wearable technology, for example, glasses, gloves, a watch, clothing, and shoes. For example, smart watches or smart glasses, and devices that focus on only one type of application function need to work with other devices such as smartphones, such as various smart bands or smart jewelry for monitoring physical signs.

Alternatively, in embodiments of this application, the multi-link STA device may be a terminal device in an Internet of things (IoT) system. IoT is an important composition part of information technology development in the future, and has a main technical feature in which things are connected to a network by using a communication technology to implement a man-machine connected and thing-thing connected intelligent network. In embodiments of this application, an IoT technology may implement massive connections, deep coverage, and terminal power saving by using, for example, a narrowband (NB) technology.

In addition, in embodiments of this application, the multi-link STA device may be a device in an Internet of vehicles system. Communication modes in an Internet of vehicles system are collectively referred to as V2X (X indicates everything) communication. For example, the V2X communication includes vehicle-to-vehicle (V2V) communication, vehicle-to-infrastructure (V2I) communication, vehicle-to-pedestrian (V2P) communication, or vehicle-to-network (V2N) communication.

In addition, in embodiments of this application, the multi-link STA device may further include a sensor such as an intelligent printer, a train detector, or a gas station. Main functions of the multi-link STA device include collecting data (by some terminal devices), receiving control information and downlink data of the multi-link AP device, sending an electromagnetic wave, and transmitting uplink data to the multi-link AP device.

In addition, the multi-link AP device in embodiments of this application may be a device configured to communicate with the multi-link STA device. The multi-link AP device may be a network device in the wireless local area network, and the multi-link AP device may be configured to communicate with the multi-link STA device by using the wireless local area network.

The multi-link AP device in embodiments of this application may be a device in a wireless network. For example, the multi-link AP device may be a communication entity such as a communication server, a router, a switch, or a network bridge, or the multi-link AP device may include various forms of macro base stations, micro base stations, relay stations, or the like. The multi-link AP may further be a chip, a circuit, or a processing system in the various forms of devices, to implement the methods and functions of embodiments of this application. The multi-link device may support high-rate and low-latency transmission. With continuous evolution of wireless local area network application scenarios, the multi-link device may be further applied to more scenarios, for example, serving as a sensor node (for example, a smart water meter, a smart electricity meter, or a smart air detection node) in a smart city, a smart device (for example, a smart camera, a projector, a display screen, a television, a stereo, a refrigerator, or a washing machine) in a smart home, a node in Internet of things, an entertainment terminal (for example, AR, VR, or another wearable device), a smart device (for example, a printer, or a projector) in a smart office, an Internet of vehicles device in Internet of vehicles, or infrastructure (for example, a vending machine, a self-service navigation console, a self-checkout device, or a self-service food machine) in daily life scenarios.

It should be understood that specific forms of the multi-link STA device and the multi-link AP device are not specifically limited in embodiments of this application, and are merely examples for description herein.

A specific structure of an execution body of a method provided in embodiments of this application is not specifically limited in embodiments of this application provided that a program that records code for the method provided in embodiments of this application can be run to perform communication according to the method provided in embodiments of this application. For example, the execution body of the method provided in embodiments of this application may be the multi-link AP device, the multi-link STA device, or a functional module that can invoke and execute a program in the multi-link AP device or the multi-link STA device.

In addition, a computer-readable medium in this application may include but is not limited to: a magnetic storage component (for example, a hard disk, a floppy disk, or a magnetic tape), an optical disc (for example, a compact disc (CD), a digital versatile disc (DVD), or the like), and a smart card and a flash memory component (for example, an erasable programmable read-only memory (EPROM), a card, a stick, a key drive, or the like). In addition, various storage media described in this specification may indicate one or more devices and/or other machine-readable media that are configured to store information. The term “machine-readable media” may include but is not limited to a wireless channel, and various other media that can store, include, and/or carry instructions and/or data.

For ease of understanding of embodiments of this application, the following first briefly describes several terms in this application.

### 1. Spatial Multiplexing

With application of a multiple-input multiple-output (MIMO) technology, a communication receiver and a communication transmitter may establish communication channels that are spatially independent of each other by using a plurality of antennas, and may transmit different data content on these channels, to implement spatial multiplexing (SM).

### 2. Multi-Link Communication

With development of wireless technologies, increasingly more wireless devices support multi-link communication. For example, a device may simultaneously perform communication on a plurality of frequency bands, for example, simultaneously perform communication on frequency bands of 2.4 gigahertz (GHz), 5 GHZ, and 6 GHz; or a device may simultaneously perform communication on different channels in a same frequency band. This can improve a communication rate between devices. The device may also be referred to as a multi-link device, for example, the multi-link access point device and the multi-link station device in the system 100 described above.

It should be understood that the multi-link device and the multi-link communication are merely names, and do not limit the protection scope of embodiments of this application. Names indicating a same meaning or a same function in a future protocol may fall within the protection scope of embodiments of this application.

For example, the multi-link device may include one or more station devices such as the STA 121 and the STA 122 shown in FIG. 1. A STA is used as an example. Each STA may work on a specified frequency band or channel.

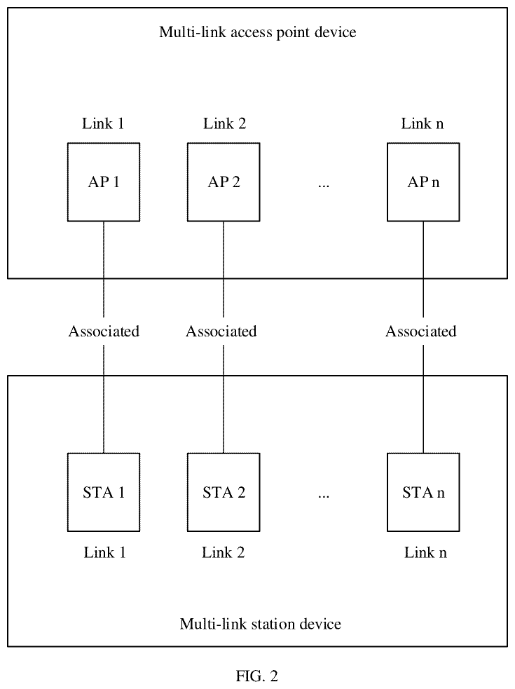

The multi-link device may be an access point device, or a station device. If the multi-link device is the access point device, the multi-link device may include one or more APs. If the multi-link device is the station device, the multi-link device may include one or more STAs (or referred to as non-AP STAs). As shown in FIG. 2, the one or more STAs (or referred to as the non-AP STAs) in the station device may communicate with the one or more APs in the access point device after an association relationship is established between the one or more STAs and the one or more APs.

As shown in FIG. 2, it is assumed that the multi-link station device includes a STA 1, a STA 2, . . . , and a STA n, and the multi-link access point device includes an AP 1, an AP 2, . . . , and an AP n, where n is an integer greater than or equal to 1. For example, the STA 1 may communicate with the AP 1 after establishing an association with the AP 1, for example, a link 1 in FIG. 2. For another example, the STA 2 may communicate with the AP 2 after establishing an association with the AP 2, for example, a link 2 in FIG. 2. For another example, the STA n may communicate with the AP n after establishing an association with the AP n, for example, a link n in FIG. 2.

Similar to spatial multiplexing, in the multi-link communication, a communication rate can be improved by using more antennas and more radio frequency (RF) chains (RF chains). However, more antennas and more radio frequency chains may cause higher energy consumption.

In view of this, this application provides a method, to properly allocate antennas and radio frequency chain resources in the multi-link communication. This achieves a balance between a high rate and low power consumption.

The following describes in detail embodiments provided in this application with reference to the accompanying drawings.

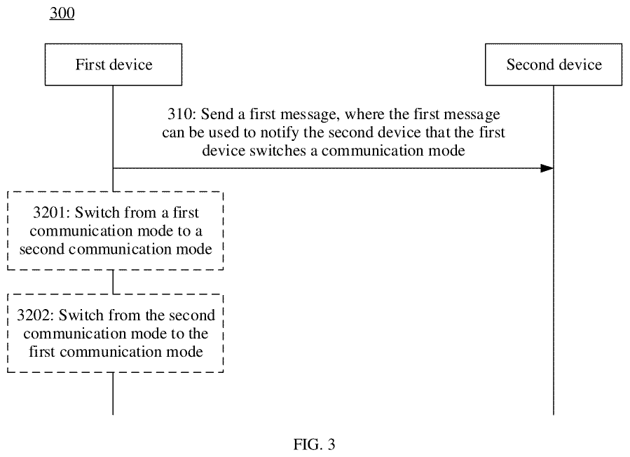

FIG. 3 is a schematic interaction diagram of a communication method 300 according to an embodiment of this application. The method 300 may include the following steps.

310: A first device sends a first message to a second device, where the first message can be used to notify the second device that the first device switches a communication mode. Correspondingly, the second device receives the first message.

It may be understood that, when wanting to switch the communication mode, the first device may send the first message to the second device. A notification may indicate that the first device notifies the second device that the first device needs to switch the communication mode; or the notification may indicate that the first device requests to the second device that the first device needs to switch the communication mode.

It should be understood that the first message is merely a general name. For example, the first message may also be referred to as a mode conversion message or a mode conversion frame, and the name of the first message does not limit the protection scope of embodiments of this application. Names indicating a same function in a future protocol all fall within the protection scope of embodiments of this application.

The following describes the first message in detail.

Optionally, the switching a communication mode includes switching from a first communication mode to a second communication mode, or the switching a communication mode includes switching from the second communication mode to the first communication mode.

For example, the first device sends the first message to the second device, where the first message is used to notify the second device that the first device switches the communication mode to the second communication mode. For example, after sending the first message to the second device, the first device enters the second communication mode. For another example, after receiving a second message from the second device, the first device enters the second communication mode.

For still another example, the first device sends the first message to the second device, where the first message is used to request to the second device that the first device switches the communication mode to the first communication mode. For example, after sending the first message to the second device, the first device enters the first communication mode. For another example, after receiving a second message from the second device, the first device enters the first communication mode. In this manner, the second device does not incorrectly switch the communication mode when the second device does not receive the first message or fails to receive the first message.

The second message may be an acknowledgment message, namely, an acknowledgment message for the first message (or an acknowledgment message of the first message). In other words, after receiving the first message, the second device may send the acknowledgment message to the first device, to indicate that the second device has received the first message. Alternatively, the second message may be a response message, namely, a response message for the first message (or a response message for the first message). In other words, after receiving the first message, the second device may send the response message to the first device, to indicate that the first device may switch the communication mode.

Optionally, the method 300 may further include step 3201 or step 3201.

3201: The first device switches from the first communication mode to the second communication mode.

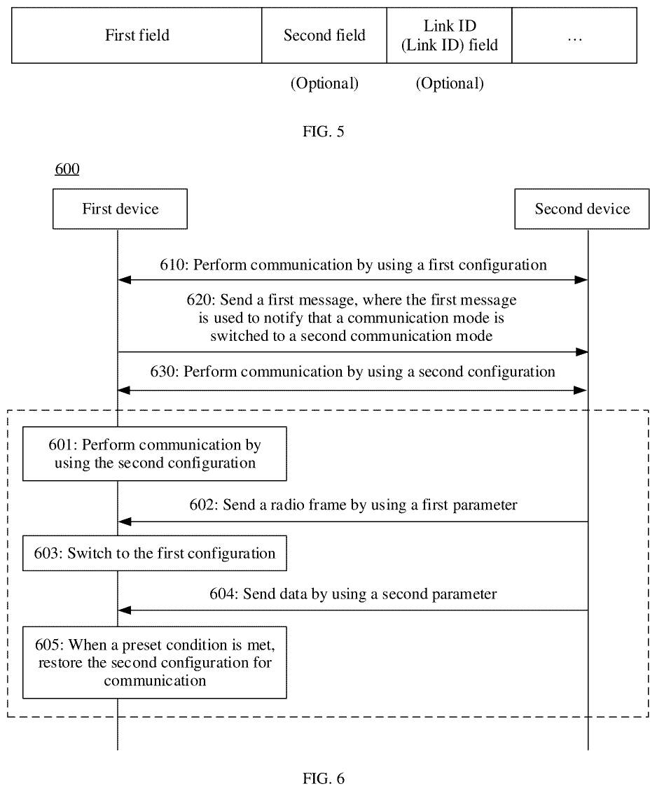

Therefore, the following describes a method 600 with reference to FIG. 6.

3202: The first device switches from the second communication mode to the first communication mode.

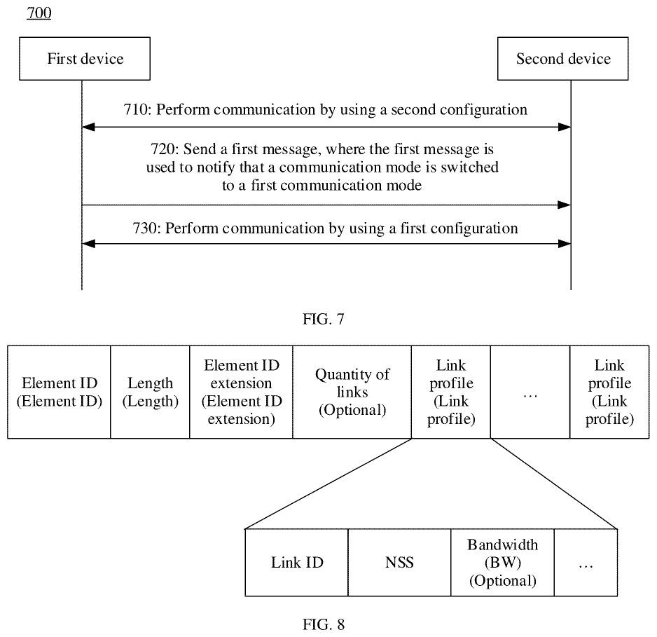

Therefore, the following describes a method 700 with reference to FIG. 7.

It should be understood that the first communication mode and the second communication mode are merely names for differentiation, and the names do not limit the protection scope of embodiments of this application. Names indicating a same function in a future protocol all fall within the protection scope of embodiments of this application. For example, the first communication mode may be referred to as a multi-link active mode (or referred to as an active mode), a multi-link conventional communication mode, or a multi-link communication mode. For another example, the second communication mode may be referred to as a multi-link power save communication mode, a multi-link communication power save mode, or a multi-link spatial multiplexing power save mode (multi-link sm power save mode). Generally, embodiments of this application are described by using the first communication mode and the second communication mode.

In a possible implementation, the first communication mode may include a first configuration, and the second communication mode may include a second configuration. In the first communication mode, the first device may perform communication by using the first configuration. In the second communication mode, the first device may perform communication by using the second configuration.

In still another possible implementation, the first communication mode may include a first configuration, and the second communication mode may include a second configuration and the first configuration. In the first communication mode, the first device may perform communication by using the first configuration. In the second communication mode, the first device may perform communication by using the second configuration, or may perform communication by using the first configuration.

In this embodiment of this application, after entering the second communication mode, the first device may switch between the first configuration and the second configuration. This can achieve a balance between a high rate and low power consumption, and improve overall system performance. The following describes in detail a solution in which after entering the second communication mode, the first device switches between the first configuration and the second configuration.

A communication resource corresponding to the first configuration is greater than a communication resource corresponding to the second configuration. In other words, the first device using the second configuration for communication is more power save than the first device using the first configuration for communication. The communication resource may include, for example, a link, a number of spatial streams (NSS), bandwidth (BW), or the like.

Optionally, under the first configuration, the first device can perform communication on N links, under the second configuration, the first device can perform communication on M links, M is an integer greater than 1 or equal to 1, N is an integer greater than 2 or equal to 2, and N is greater than M.

In other words, under the first configuration, the first device may be supported to perform communication on the N links; and under the second configuration, the first device may be supported to perform communication on the M links.

It may be understood that, under the first configuration, the first device may work on two or more links, and may perform communication on each link by using one or more radio frequency chains. Under the second configuration, the first device may work on one or more links, and may perform communication on each link by using one or more radio frequency chains.

In a possible implementation, the first configuration corresponds to a plurality of links, and the second configuration corresponds to a single link. In other words, under the first configuration, the first device may work on the plurality of links; and under the second configuration, the first device may work on the one link. When a transmission service amount is large, a plurality of links may be used for communication, to improve a communication rate and reduce a communication latency. A quantity of links used for multi-link communication may further be determined based on an actual service requirement. When a transmission service amount is small, only a single link may be used for communication, to reduce an energy loss. This achieves a balance between a high rate and low power consumption.

In this embodiment of this application, as a multi-link device, the first device may dynamically switch between different communication modes. For example, the first device may dynamically switch between different communication modes based on different communication environments, for example, based on a communication requirement of service data. In addition, the first communication mode and the second communication mode correspond to respective configuration information. For example, the first communication mode includes the first configuration, and the second communication mode includes the first configuration and the second configuration. Therefore, after the communication mode is switched, the corresponding configuration may be used for communication, and each station of the first device does not need to send an operating mode indication (OMI) to change an operating parameter on an operating link of the station. Therefore, this can not only achieve a balance between a high rate and low power consumption, but also can reduce signaling overheads and a waste of resources.

Optionally, the first configuration or the second configuration may include one or more communication parameters.

For example, the communication parameter may include a link ID. By using the link ID, the first device may determine a communication link, or in other words, determining a link on which communication is performed, to perform communication on the determined link. This improves communication performance. In addition, the communication parameters may further include a number of spatial streams of the link, bandwidth of the link, whether to support uplink multi-user transmission, and whether to support an extended-range transmission mode. By using the communication parameters, the first device may perform communication based on the communication parameters.

The following describes manners of determining the first configuration and the second configuration.

### (1) First Configuration

Manner 1: One or more stations of the first device separately send information about the first configuration to one or more stations of the second device.

In other words, the one or more stations of the first device separately send the configuration information to the one or more stations of the second device, to separately indicate an operating parameter of each station of the first device.

Manner 2: One station of the first device sends information about the first configuration to one station of the second device.

In other words, the one station of the first device sends the configuration information to the one station of the second device, to indicate an operating parameter of each station on the plurality of links of the first device.

The operating parameter may include the link ID. In addition, operating parameters may further include operating bandwidth, an NSS, whether to support uplink multi-user transmission, and whether to support an extended-range transmission mode.

For example, the first configuration may be carried in existing signaling. For example, the first configuration may be carried in an OMI control information field, or carried in an extremely high throughput (EHT) operation element (EHT operation element).

### (2) Second Configuration

Manner 1: The second configuration is a fixed configuration.

In other words, the second configuration may be a pre-specified configuration, for example, predefined in a protocol. For example, the second configuration corresponds to a single link, a single stream, and fixed bandwidth (for example, 20 megahertz (Mega Hertz, MHz) bandwidth).

Manner 2: One or more stations of the first device separately send information about the second configuration to one or more stations of the second device.

Manner 3: One station of the first device sends information about the second configuration to one station of the second device.

It should be understood that the following describes in detail a solution in which the first device indicates operating parameters (or configuration information) of the plurality of links by using one piece of signaling.

The following describes the first message in detail from two aspects.

Aspect 1: Information that may be included in the first message.

Optionally, the first message may include one or more of the following: first information, information about a communication link, and second information. Description is separately provided below.

### 1. First Information.

The first information may indicate whether the first device switches the communication mode or whether the first device switches from the first communication mode to the second communication mode. For example, it is assumed that a first field of the first message carries the first information. Different values of the first field may indicate whether the first device switches the communication mode.

It is assumed that the values of the first field may be a first value and a second value, and the first value and the second value are different. For example, the first value is 0, and the second value is 1; or the first value is 1, and the second value is 0.

In a possible implementation, when a value of the first field is the first value, it may indicate that the first device switches the communication mode; or when a value of the first field is the second value, it may indicate that the first device does not switch the communication mode, that is, continues to maintain a current communication mode. It is assumed that the current communication mode of the first device is the first communication mode.

The second device is used as an example. The second device may determine, based on the value of the first field, whether the first device needs to switch the communication mode. For example, if the value of the first field is the first value, it indicates that the first device switches the communication mode, that is, the first device enters the second communication mode. If the value of the first field is the second value, it indicates that the first device does not switch the communication mode, that is, the first device continues to perform communication in the first communication mode.

The first device is used as an example. The first device determines the value of the first field based on whether to switch the communication mode. For example, if the first device needs to switch the communication mode, in the first message sent by the first device to the second device, the value of the first field is the first value, and the first value is used to notify the second device that the first device switches the communication mode to the second communication mode.

If the first device does not switch the communication mode, in the first message sent by the first device to the second device, the value of the first field is the second value, and the second value is used to notify the second device that the first device does not switch the communication mode, that is, the first device continues to perform communication in the first communication mode.

It should be understood that the foregoing is merely an example for description, and this embodiment of this application is not limited thereto. For example, if the first device does not switch the communication mode, the first device may not send the first message to the second device.

It should be further understood that specific content indicated by the first field is not limited in this embodiment of this application, provided that the second device can learn, by using the first field, of a communication mode in which the first device expects to perform communication. This falls within the protection scope of embodiments of this application.

2. Information about a Communication Link.

The information about the communication link may indicate a communication link obtained after the communication mode is switched. For example, the information about the communication link may include an identifier (ID) of the communication link. It is assumed that a link ID field carries the information about the communication link.

For example, it is assumed that a current communication mode of the first device is the first communication mode, and communication links of the first device include a link 1 and a link 2. If the first device sends the first message to the second device to notify the first device to switch from the first communication mode to the second communication mode, and the first message includes an ID of the link 2, the second device may determine, based on the first message, that the first device is to switch the communication mode to the second communication mode, and after switching to the second communication mode, performs communication by using the link 2.

### 3. Second Information.

The second information may indicate whether the first device can switch between a plurality of configurations in the second communication mode, for example, in the second communication mode, whether the first device can switch between the first configuration and the second configuration.

The following describes the second information in detail.

The foregoing describes the information that may be included in the first message. It should be understood that the first message may further include more information. This is not limited in this embodiment of this application. In addition, a name of each piece of information is not limited in this embodiment of this application. The following describes a frame structure applicable to the first message.

Aspect 2: The frame structure applicable to the first message.

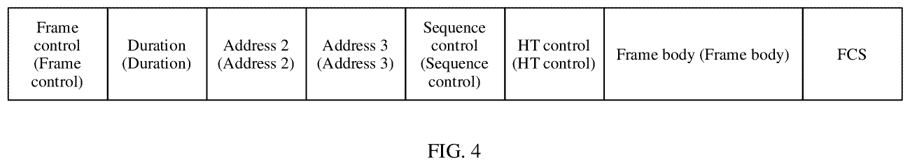

A specific form of the first message is not limited in this embodiment of this application. With reference to possible frame structures shown in FIG. 4 and FIG. 5, the following describes, by using an example, a possible frame structure applicable to the first message.

In a possible implementation, the first message may be transmitted by using an EHT action frame, which may be, for example, referred to as a mode switching frame. A frame structure of the EHT action frame is shown in FIG. 4.

As shown in FIG. 4, the frame structure may include, for example, but is not limited to a frame control field, a duration field, an address (for example, an address 2 and an address 3) field, a sequence control field, a high throughput control (HT control) field, a frame body field, and a frame check sequence (FCS) field.

For example, the frame body may include one or more pieces of information. For example, the frame body may include information shown in the following Table 1.

TABLE 1

| Order (order) | Information (information) |
|---|---|
| 1 | Category (category) |
| 2 | EHT action |
| 3 | Control #A field (control field) |

It should be understood that content of Table 1 is merely an example, and this embodiment of this application is not limited thereto. For example, the frame body may further include more content.

It should be further understood that names of the foregoing pieces of information are merely used to distinguish between different functions, and do not limit the protection scope of embodiments of this application. Names indicating a same function in a future protocol all fall within the protection scope of embodiments of this application. For example, the control #A field may also be referred to as an ML spatial multiplexing (SM) power save (ML SM power save) control field.

The first information, the information about the communication link, and the second information in the first message may all be carried in the control field #A.

FIG. 5 shows a possible frame structure of the control field #A. As shown in FIG. 5, the frame structure of the control #A field may include a first field. Optionally, the frame structure of the control #A field may further include but is not limited to a second field and a link ID field.

The first field may also be referred to as, for example, a mode enabled field or an ML SM power save mode enabled field. A name of the first field does not limit the protection scope of embodiments of this application. Different values of the first field may indicate whether the first device needs to switch the communication mode. For example, if a value of the first field is 1, it indicates that the first device switches the communication mode; or if a value of the first field is 0, it indicates that the first device does not switch the communication mode, that is, still uses a current communication mode.

For example, the current communication mode of the first device is the first communication mode. If the value of the first field is 1, it indicates that the first device enters the second communication mode. If the value of the first field is 0, it indicates that the first device does not switch the communication mode, that is, the first device continues to communicate with the second device in the first communication mode.

The link ID field may also be referred to as, for example, a link field, and a name of the link ID field does not limit the protection scope of embodiments of this application. The link ID field is used to carry information about a communication link. Optionally, when the first device continues to perform communication in the current communication mode, it indicates that the first device may still perform communication by using a current communication link. In this case, the link ID field may not carry the information about the communication link. For example, the link ID field may be used as a reserved field.

The second field may also be referred to as, for example, a dynamic field, and a name of the second field does not limit the protection scope of embodiments of this application. The second field may be used to carry the second information. For example, when a value of the second field is 0, it indicates that in the second communication mode, the first device does not switch between the plurality of configurations; or in the second communication mode, the first device performs communication only by using the second configuration. For another example, when the value of the second field is 1, it indicates that in the second communication mode, the first device may switch between the plurality of configurations.

It should be understood that the frame structures shown in FIG. 4 and FIG. 5 are merely examples for description, and any variation belonging to the structures falls within the protection scope of embodiments of this application. For example, in the frame structure shown in FIG. 5, the frame structure of the control #A field may further include more fields.

For ease of understanding, the following describes a communication mode switching procedure with reference to two scenarios.

Scenario 1: The first device switches from the first communication mode to the second communication mode.

The following provides an example for description with reference to FIG. 6.

FIG. 6 is a schematic interaction diagram of a communication method 600 applicable to an embodiment of this application. The method 600 may include the following steps.

610: The first device communicates with the second device by using a first configuration.

In other words, in the first communication mode, the first device may communicate with the second device by using the first configuration.

620: The first device sends a first message to the second device, where the first message is used to notify that a communication mode is switched to the second communication mode.

For the first message, refer to the description in the foregoing method 300. Details are not described herein again.

The frame structure shown in FIG. 5 is used as an example. It is assumed that the value of the first field is 1, it indicates that the first device switches the communication mode; and that the value of the first field is 0, it indicates that the first device does not switch the communication mode, that is, still uses a current communication mode.

In the scenario 1, the value of the first field may be 1. After receiving the first message, the second device may determine, based on that the first field is 1, that the first device switches the communication mode to the second communication mode.

630: The first device may communicate with the second device by using the second configuration.

In other words, after entering the second communication mode, the first device may communicate with the second device by using the second configuration.

In a possible implementation, after sending the first message to the second device, the first device enters the second communication mode; and after receiving the first message from the first device, the second device enters the second communication mode.

In still another possible implementation, after receiving a second message, the first device enters the second communication mode; and after sending the second message to the first device, the second device enters the second communication mode. For example, after receiving the first message from the first device, the second device may send an acknowledgment message for the first message to the first device, that is, confirm that the first device enters the second communication mode. For another example, after the receiving the first message from the first device, the second device may send a response message for the first message to the first device, that is, the first device may enter the second communication mode.

In this embodiment of this application, the first device may disable an unnecessary link when a communication service requirement is low, and reduce a number of spatial streams of the link to a minimum, to achieve an power save objective.

Optionally, in the second communication mode, the first device may always perform communication by using the second configuration, or may switch between a plurality of configurations (for example, the first configuration and the second configuration). The following describes in detail a case in which switching is performed between the first configuration and the second configuration.

Optionally, the method 600 may further include step 601 to step 605.

601: The first device performs communication by using the second configuration.

602: The second device sends a radio frame to the first device by using a first parameter.

For example, when the second device needs to transmit data to the first device, the second device may send the radio frame to the first device by using the first parameter. The first device may determine, by using the radio frame, that the second device is to transmit the data to the first device.

In this embodiment of this application, the first parameter indicates a parameter supported by the second configuration. In other words, the second device sends the radio frame to the first device by using the parameter supported by the second configuration.

In this embodiment of this application, if a parameter is a parameter supported by a configuration, for example, the first parameter is a parameter supported by the second configuration, it may indicate that a link of the parameter is a subset of links of the configuration, a number of spatial streams of each link of the parameter is less than or equal to a number of spatial streams of a corresponding link of the configuration, or bandwidth on each link of the parameter is less than or equal to bandwidth on a corresponding link of the configuration. This is not described in the following again.

603: The first device switches to the first configuration.

Optionally, before receiving the radio frame and switching to the first configuration, the first device may send a third message to the second device. The third message may be an acknowledgment frame for the radio frame, or an acknowledgment message for the radio frame.

After sending the acknowledgment frame (namely, the acknowledgment message) for the radio frame to the second device, the first device switches to the first configuration.

604: The second device sends the data to the first device by using a second parameter.

Optionally, after receiving the acknowledgment frame (namely, the acknowledgment message) from the first device, the second device may send the data to the first device by using the second parameter. Based on this solution, the second device can confirm that the first device has successfully received the radio frame. This avoids a data transmission failure and improves data transmission performance.

In this embodiment of this application, the second parameter indicates a parameter supported by the first configuration.

It should be understood that an occasion on which the first device switches to the first configuration is not limited in this embodiment of this application. For example, the first device may switch to the first configuration after receiving the radio frame sent by the second device by using the first parameter; or the second device may send the data to the first device by using the second parameter after sending the radio frame to the first device by using the first parameter.

605: When a preset condition is met, the first device restores the second configuration for communication.

It may be understood that, in the second communication mode, the first device may switch from the second configuration to the first configuration, or may switch from the first configuration back to the second configuration.

In this embodiment of this application, after entering the second communication mode, the multi-link device (for example, the first device) may dynamically switch between different configurations (for example, the first configuration and the second configuration). This can achieve a balance between a high rate and low power consumption.

In a possible case, the preset condition may indicate whether sending of the data by the second device to the first device ends.

For example, that sending of the data ends or that data transmission ends may indicate that all data transmitted by the second device to the first device is transmitted, or that the second device completes data transmission to the first device.

For example, after sending of the data by the second device to the first device ends, the first device may restore the second configuration for use. This reduces power consumption.

In still another possible case, the preset condition may indicate whether sending of data by the second device on some links included under the first configuration ends.

For example, sending of the data by the second device on the some links included under the first configuration ends, the first device may restore the second configuration for use. In other words, after sending of most data ends, the first device may restore the second configuration for use.

For another example, after sending of the data by the second device on the some links included under the first configuration ends, the first device may disable the links. This saves more energy. There are a plurality of manners of determining links on which data has been sent. This is not limited in this embodiment of this application. For example, a link on which data has been sent may be determined based on a third field on each link. For another example, a link on which data has been sent may be determined in a bitmap manner.

It should be understood that, for the preset condition, the foregoing two cases are merely examples for description. This is not limited in this embodiment of this application. For example, the second device may notify the first device to restore the second configuration for communication.

Optionally, the first device may determine, by using the following method, whether sending of the data by the second device ends, or whether the data transmission of the second device ends.

Method 1: The second device sends a data frame on all links included under the first configuration, and determines, based on a third field of the data frame, whether sending of the data by the second device ends. The third field may indicate whether sending of the data ends.

Optionally, the third field may be, for example, a more data field. Whether sending of the data ends may be determined based on the more data field in the data frame. The following uses the more data field as an example for description.

For example, whether sending of the data ends may be determined based on a value of the more data field.

For example, the second device sends the data frame on all the links included under the first configuration. If the value of the more data field in the data frame sent by the second device on each link is 0, the first device may consider that sending of the data by the second device ends, so that the first device may restore the second configuration for use.

For another example, the second device sends the data frame on all the links included under the first configuration. If the value of the more data field in the data frame sent by the second device on some links is 0, the first device may consider that sending of the data by the second device ends, so that the first device may restore the second configuration for use.

For another example, the second device sends the data frame on all the links included under the first configuration. If the value of the more data field in the data frame sent by the second device on some links is 0, the first device may consider that sending of the data by the second device on the links ends, so that the first device may disable the links.

It should be understood that the more data field is merely an example for description, and this embodiment of this application is not limited thereto. For example, a field may be redefined in the data frame as the third field.

Method 2: Whether sending of the data by the second device ends is determined based on control information carried by the second device in the data frame.

For example, the control information is carried in a fourth field. In this case, it may be determined, based on a value of the fourth field, whether sending of the data by the second device ends.

The fourth field may be, for example, a multi-link more data field, and a name of the fourth field does not limit the protection scope of embodiments of this application.

Optionally, the first device may determine, based on the value of the fourth field, whether sending of the data by the second device ends. It is assumed that values of the fourth field may be a third value and a fourth value, and the third value and the fourth value are different. For example, when the value of the fourth field is the third value, it indicates that sending of the data by the second device ends, so that the first device may restore the second configuration for use; or when the value of the fourth field is the fourth value, it indicates that sending of the data by the second device does not end, so that the first device continues to use the first configuration. For example, the third value is 0, and the fourth value is 1; or the third value is 1, and the fourth value is 0.

For example, the fourth field may be a newly defined field, or may be an existing field. This is not limited herein.

For example, the fourth field may be carried at a physical layer, for example, carried in a signaling field of a physical layer preamble; or may be carried in media access control (MAC), for example, carried in a MAC header. For example, the fourth field is carried in the MAC. For example, the fourth field may be carried in an OMI field or a command and status (CAS) field. For another example, a new control information type may be defined to carry the fourth field. For example, the new control information type is defined in a high efficiency (HE) variant of a high throughput (HT) control field (HE variant of HT Control field) to carry the fourth field.

It should be understood that, similar to the method 1, in the method 2, after determining that sending of data on all links ends, the first device may restore the second configuration for use. Alternatively, after determining that sending of data on some links ends, the first device may restore the second configuration for use. Alternatively, after determining that sending of data on some links ends, the first device may disable the some links.

It should be further understood that the foregoing two methods are merely examples for description. This is not limited in this embodiment of this application. Any method that can enable the first device to determine whether sending of the data by the second device ends can be used in this embodiment of this application.

It should be further understood that a solution in which the first device determines whether sending of the data by the second device ends may be used independently, or may be used in combination with the solution in the method 300. In an example, a solution in which the first device determines whether sending of the data by the second device ends may be used in combination with the solution in the method 300. For example, after the first device switches to the second communication mode, the second device transmits the data to the first device by using the first configuration. After determining, by using the foregoing method, that sending of the data ends, the first device may continue to be in the second communication mode, and restore the second configuration for communication. In still another example, a solution in which the first device determines whether sending of the data by the second device ends may be independently used. For example, after determining, by using the foregoing method, that sending of the data ends, the first device may enter a sleep mode.

Optionally, the second information in the first message may indicate whether the first device can switch, after entering the second communication mode, to the first configuration after receiving the radio frame from the second device, and switch to the second configuration again after the preset condition is met, for example, after the data is received. For example, the second information in the first message may indicate whether operations of step 603 to step 605 can be performed.

For example, the second information is carried in a second field, and may be determined based on a value of the second field. For example, when the value of the second field is 1, it indicates that the operations of step 603 to step 605 may be performed; or when the value of the second field is 0, it indicates that the operations of step 603 to step 605 are not performed. Alternatively, in other words, in the second communication mode, the first device always uses the second configuration for communication.

The foregoing describes in detail content of switching from the first communication mode to the second communication mode by the first device. The following describes a case in which the first device switches from the second communication mode to the first communication mode.

Scenario 2: communication modes of the first device and the second device are switched from the second communication mode to the first communication mode.

The following provides an example for description with reference to FIG. 7.

FIG. 7 is a schematic interaction diagram of a communication mode switching method 700 applicable to still another embodiment of this application. The method 700 may include the following steps.

710: The first device may communicate with the second device by using a second configuration.

In other words, in the second communication mode, the first device communicates with the second device by using the second configuration.

720: The first device sends a first message to the second device, where the first message is used to notify that the communication mode is switched to the first communication mode.

For the first message, refer to the description in the foregoing method 300. Details are not described herein again.

The frame structure shown in FIG. 5 is used as an example. It is assumed that a value of a first field is 1, it indicates that the first device switches the communication mode; and that the value of the first field is 0, it indicates that the first device does not switch the communication mode, that is, still uses a current communication mode.

In the scenario 2, the value of the first field may be 1. After receiving the first message, the second device may determine, based on that the first field is 1, that the first device switches the communication mode to the first communication mode.

730: The first device may communicate with the second device by using the first configuration.

In other words, after entering the first communication mode, the first device may communicate with the second device by using the first configuration.

In a possible implementation, after sending the first message to the second device, the first device enters the first communication mode; and after receiving the first message from the first device, the second device enters the first communication mode.

In still another possible implementation, after receiving a second message, the first device enters the first communication mode; and after sending the second message to the first device, the second device enters the first communication mode. For example, after receiving the first message from the first device, the second device may send an acknowledgment message for the first message to the first device, that is, confirm that the first device enters the first communication mode. For another example, after the receiving the first message from the first device, the second device may send a response message for the first message to the first device, that is, the first device may enter the first communication mode.

The foregoing describes two switching scenarios. The following describes several possible cases of a configuration used by the first device for communication in the second communication mode.

It is assumed that, in the second communication mode, the first device performs communication by using the second configuration.

Case 1: The first device communicates with the second device by using the first configuration.

It may be understood that, in the case 1, in the second communication mode, the first device may switch from the second configuration to the first configuration.

In a possible implementation, the second device sends a radio frame to the first device by using a first parameter. After receiving the radio frame, the first device sends a third message (or sends an acknowledgment frame) to the second device. It may be understood that, after sending the third message, the first device switches to the first configuration, that is, communicates with the second device by using the first configuration. After receiving the third message, the second device may send data to the first device by using a second parameter.

In still another possible implementation, the second device sends the radio frame to the first device by using the first parameter. After receiving the radio frame, the first device may directly switch to the first configuration. It may be understood that, after receiving the radio frame sent by the second device, the first device switches to the first configuration, that is, communicates with the second device by using the first configuration. After sending the radio frame, the second device may send the data to the first device by using the second parameter.

Optionally, when a preset condition is met, the first device restores the second configuration for communication.

For the case 1, refer to the description in the foregoing method 600. Details are not described herein again.

Based on the foregoing case 1, the first device may switch from performing communication by using the second configuration to performing communication by using the first configuration. In addition, after entering the second communication mode (or referred to as a multi-link power save mode), multi-link devices (for example, the first device and the second device) may dynamically switch between the first configuration and the second configuration. This can achieve a balance between a high rate and low power consumption.

Case 2: The first device communicates with the second device by using a third configuration recommended by the second device.

It may be understood that, in the case 2, in the second communication mode, the first device and the second device may switch from the second configuration to the third configuration.

The second device may send information about the third configuration to the first device. Alternatively, it may be understood that the second device recommends, to the first device, the third configuration for communication. In other words, the second device sends a configuration recommendation frame to the first device.

In a possible implementation, the second device sends the information about the third configuration to the first device by using the first parameter. After receiving the information about the third configuration, the first device sends a third message to the second device (or in other words, sends an acknowledgment frame or sends a configuration acknowledgment frame). It may be understood that, after sending the third message, the first device switches to the third configuration, that is, communicates with the second device by using the third configuration. After receiving the third message, the second device may send data to the first device by using a third parameter. The third parameter is a parameter supported by the third configuration.

In still another possible implementation, the second device sends the information about the third configuration to the first device by using the first parameter. After receiving the information about the third configuration, the first device may directly switch to the third configuration. After receiving the information that is about the third configuration and that is sent by the second device, the first device switches to the third configuration, that is, communicates with the second device by using the third configuration. After sending the information about the third configuration, the second device may send the data to the first device by using the third parameter.

Optionally, when the preset condition is met, the first device may restore the second configuration for use.

For this, refer to the description in step 605 in the method 600. Details are not described herein again.

Optionally, the information about the third configuration may include, for example, a group of configuration parameters, namely, configuration parameters used when the second device subsequently sends a data frame to the first device. For example, the configuration parameter may include one or more link IDs. In addition, the configuration parameters may further include operating bandwidth of each link, an NSS of each link, whether to support uplink multi-user transmission, whether to support an extended-range transmission mode, and the like.

The one or more link IDs indicate one or more links used when the second device subsequently sends the data frame to the first device. Correct communication can be implemented by learning the link ID.

A number of spatial streams of each link may indicate a number of spatial streams used when the second device subsequently sends the data frame to the first device. The number of spatial streams may include, for example, a number of transmit (Tx) spatial streams (Tx NSS), or may include a number of receive (Rx) spatial streams (Rx NSS).

The bandwidth of each link may indicate bandwidth used when the second device subsequently sends the data frame to the first device, for example, maximum bandwidth used when the second device subsequently sends the data frame to the first device.

The following describes a frame structure that carries the information about the third configuration.

In a possible design, the information about the third configuration may be carried by using a frame structure shown in FIG. 8.

As shown in FIG. 8, the frame structure may include, for example, an element ID field, a length (namely, a frame length) field, an element ID extension field, and a link profile of each link (or information about each link). Optionally, the frame structure may further include a quantity of links (number of links).

For example, the link profile may include a link ID and a number of spatial streams (namely, a number of spatial streams of a link, or both of a Tx NSS and an Rx NSS that may be indicated by using one parameter). Alternatively, bandwidth (namely, bandwidth of the link, for example, maximum bandwidth of the link) may be further included.

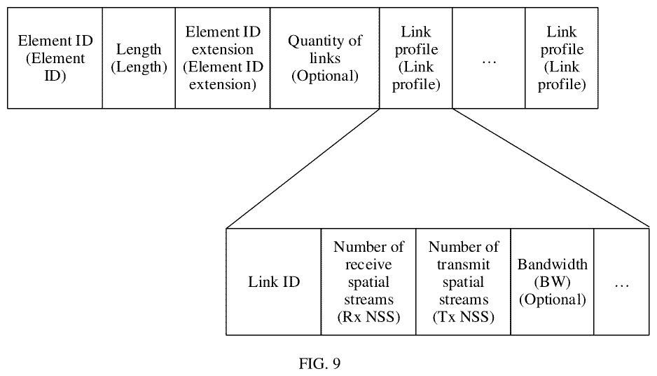

In still another possible design, the information about the third configuration may be carried by using a frame structure shown in FIG. 9.

Different from FIG. 8, in the frame structure shown in FIG. 9, a number of spatial streams of each link may include a Tx NSS and an Rx NSS.

It should be understood that the frame structures shown in FIG. 8 and FIG. 9 are merely examples for description. This is not limited in this embodiment of this application. For example, the frame may include more fields or fewer fields.

Based on the foregoing case 2, the first device may switch from performing communication by using the second configuration to performing communication by using the third configuration. In addition, the second device may recommend, to the first device based on an actual communication requirement, a configuration parameter, namely, the third configuration, for transmitting a data frame. This can improve data transmission performance.

Case 3: The first device uses, for communication, a fourth configuration obtained after the third configuration is adjusted.

It may be understood that, in the case 3, in the second communication mode, the first device may switch from the second configuration to the fourth configuration.

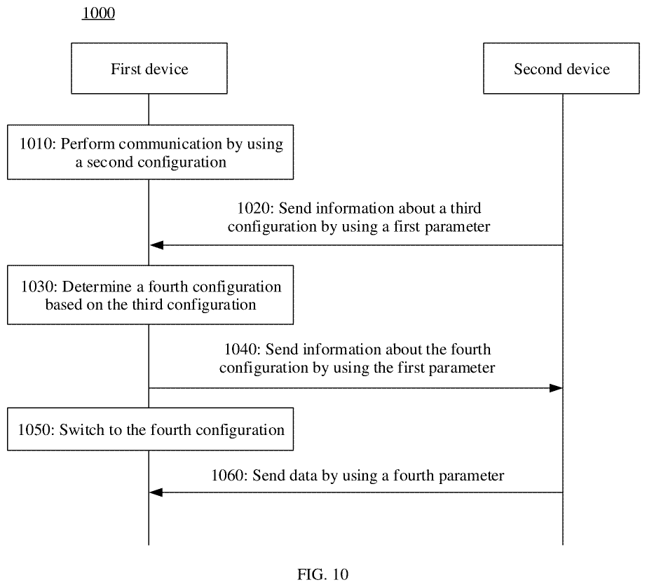

The following provides description by using an example with reference to a method 1000 shown in FIG. 10.

1010: The first device performs communication by using the second configuration.

1020: A second device sends information about the third configuration to the first device by using a first parameter.

In other words, the second device sends a configuration recommendation frame to the first device. The first parameter indicates a parameter supported by the second configuration.

For the third configuration, refer to the description in the case 2. Details are not described herein again.

1030: The first device determines the fourth configuration based on the third configuration.

A manner in which the first device determines the fourth configuration based on the third configuration is not limited in this embodiment of this application. For example, the first device may adjust a parameter of the third configuration (for example, the first device may adjust a quantity of links of the third configuration) based on an actual communication status or a network environment, to obtain the fourth configuration.

After the second device recommends the third configuration to the first device, the first device may adjust the parameter configuration. In this way, excessive links, spatial streams, and bandwidth are not used. This reduces an energy waste.

1040: The first device sends information about the fourth configuration to the second device by using the first parameter, where the information about the fourth configuration includes a configuration parameter to be used by the first device in subsequent data transmission.

In other words, the first device sends a configuration acknowledgment frame to the second device by using the first parameter, and the fourth configuration is a configuration indicated in the configuration acknowledgment frame.

Optionally, after receiving the information about the third configuration and before switching to the fourth configuration, the first device may send a third message to the second device, where the third message includes the information about the fourth configuration, and the third message is used to notify the first device of the configuration parameter to be used in the subsequent data transmission.

Optionally, the information about the fourth configuration may include, for example, a group of configuration parameters, namely, configuration parameters used when the second device subsequently sends a data frame to the first device. The configuration parameter may include one or more link IDs. In addition, the configuration parameters may further include operating bandwidth of each link, an NSS of each link, whether to support uplink multi-user transmission, whether to support an extended-range transmission mode, and the like.

For the foregoing parameters, refer to the description in the case 2.

Optionally, the information about the fourth configuration may be carried by using the frame structure shown in FIG. 8 or FIG. 9.

1050: The first device switches to the fourth configuration.

Optionally, after sending the information about the fourth configuration to the second device, the first device may switch to the fourth configuration.

1060: The second device sends the data to the first device by using a fourth parameter.

In this embodiment of this application, the fourth parameter indicates a parameter supported by the fourth configuration.

Optionally, when the preset condition is met, the first device may restore the second configuration for use.

For this, refer to the description in step 605 in the method 600. Details are not described herein again.

Based on the foregoing case 3, the first device may switch from performing communication by using the second configuration to performing communication by using the fourth configuration. In addition, the first device may adjust the parameter configuration of the first device based on a configuration of the data frame subsequently sent by the second device, to avoid using excessive links, spatial streams, and bandwidth. This reduces an energy waste. In addition, an objective of using a most appropriate configuration for communication can be achieved by using the configuration recommendation frame (for example, the third configuration) and the configuration acknowledgment frame (for example, the fourth configuration).

The foregoing describes, by using the three cases, the configuration used by the first device for communication in the second communication mode. After entering the second communication mode (or the multi-link power save mode), the multi-link device (for example, the first device) may dynamically switch between the plurality of configurations (for example, between the second configuration and the first configuration, between the second configuration and the third configuration, or between the second configuration and the fourth configuration) by using the foregoing solution. This achieves a balance between a high rate and low power consumption, and achieves the objective of using a most appropriate configuration for communication.

Information that indicates a link, for example, indicates the configuration information (for example, the first configuration, the second configuration, the third configuration, or the fourth configuration) and that is mentioned above in a plurality of parts includes information about one or more links. With reference to FIG. 11, the following describes in detail a solution in which operating parameters of a plurality of links are indicated by using one piece of signaling. It should be understood that the solution shown in FIG. 11 may be used independently, or may be used in combination with the solution of the method 300, the method 600, or the method 700.

FIG. 11 is a schematic diagram of another communication mode switching method 1100 according to still another embodiment of this application.

1110: A first device sends a configuration frame to a second device, where the configuration frame carries configuration information #A, and the configuration frame indicates operating mode information of a plurality of links.

1120: The second device sends an acknowledgment frame to the first device.

After sending the acknowledgment frame, the second device performs transmission with the first device by using a transmission parameter supported by the configuration information #A.

In this embodiment of this application, the operating mode information of the plurality of links may be indicated at a time by using one piece of signaling, and the plurality of links do not need to be separately enabled. The operating mode information of each link is indicated one by one by using each link. This further reduces energy consumption.

It should be understood that this embodiment of this application is mainly described by using an example in which the configuration frame indicates the operating mode information of the plurality of links. This is not limited in this embodiment of this application. The solution in this embodiment of this application may also be applicable to a case in which the configuration frame indicates operating mode information of one link.

In this embodiment of this application, it is considered that one RF chain may be used to add a new communication link, or may be used to increase a number of spatial streams of a link. A quantity of newly added links may be determined based on various factors, or the number of spatial streams of the link may be increased. The factors may include but are not limited to a relationship between bandwidth of a newly added link and bandwidth of an existing link, whether multi-link devices (for example, the first device and the second device) can perform simultaneous receiving and sending between the newly added link and the existing link, and a channel busy/idle state of the newly added link, for example, a percentage of busy channels, channel state information of the newly added link and the existing link, and the like. When the factors change, the multi-link devices (for example, the first device and the second device) need to flexibly change RF chain configurations of the multi-link devices, to implement efficient resource utilization. Therefore, in this embodiment of this application, configurations of a link and a number of spatial streams may be changed. For example, when the configuration frame is sent, a relatively optimal configuration or an optimal configuration may be selected, to flexibly configure an RF chain resource, and properly use the RF chain. Details are described below.

For example, the configuration information #A may be the information about the first configuration described above. In other words, when indicating the information about the first configuration to the second device, the first device may indicate the information about the first configuration by using the solution described in the method 1100. For another example, the configuration information #A may be, for example, the information about the second configuration described above. In other words, when indicating the information about the second configuration to the second device, the first device may indicate the information about the second configuration by using the solution described in the method 1100. For another example, the configuration information #A may be, for example, the information about the third configuration described above. In other words, when indicating the information about the third configuration to the first device, the second device may indicate the information about the third configuration by using the solution described in the method 1100. For another example, the configuration information #A may be, for example, the information about the fourth configuration described above. In other words, when indicating the information about the fourth configuration to the second device, the first device may indicate the information about the fourth configuration by using the solution described in the method 1100. It should be understood that FIG. 11 is mainly described by using an example in which the first device sends the indication information to the second device. When the second device indicates the information about the third configuration to the first device, this solution may also be used.

It should be understood that the configuration information #A is merely a general name, and does not limit the protection scope of embodiments of this application.

The configuration frame is a frame indicating the configuration information #A. It should be understood that the configuration frame is merely a name for differentiation, and does not limit the protection scope of embodiments of this application. The configuration frame may indicate the operating mode information of the plurality of links. It should be understood that this embodiment of this application is also applicable to a case in which the operating mode information of the one link of one link is indicated. The operating mode information may include, for example, a number of spatial streams of a link and bandwidth of the link. Optionally, the configuration frame may further include other operating mode information, for example, whether to support uplink multi-user transmission, whether to support an extended-range transmission mode, and the like.

For example, as shown in the frame structure in FIG. 9, the number of spatial streams of the link may include a Tx NSS and an Rx NSS. Alternatively, for example, as shown in the frame structure in FIG. 8, one parameter may indicate both of the Tx NSS and the Rx NSS. Optionally, the configuration frame may be sent by a station of the first device.

Optionally, the configuration frame may be transmitted by using an existing frame; or

the configuration frame may be transmitted by using a newly defined frame (for example, a management frame), for example, the EHT action frame shown in FIG. 4.

For example, the frame body may include one or more pieces of information. For example, the frame body may include information shown in the following Table 2.

TABLE 2

| Order | Information |
|---|---|
| 1 | Category |
| 2 | EHT action |
| 3 | Configuration information #A |

It should be understood that content of Table 2 is merely an example, and this embodiment of this application is not limited thereto. For example, the frame body may further include more content.

It should be further understood that names of the foregoing pieces of information are merely used to distinguish between different functions, and do not limit the protection scope of embodiments of this application. Names indicating a same function in a future protocol all fall within the protection scope of embodiments of this application. For example, a field used to carry the configuration information #A may be an ML SM configuration information element field.

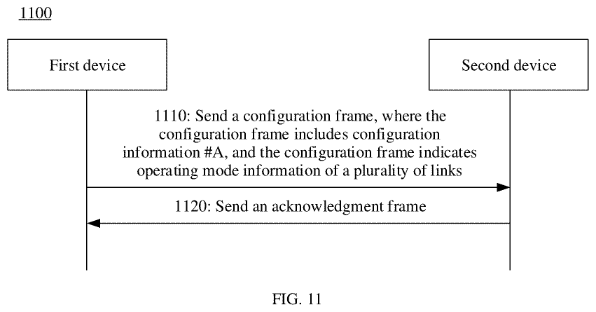

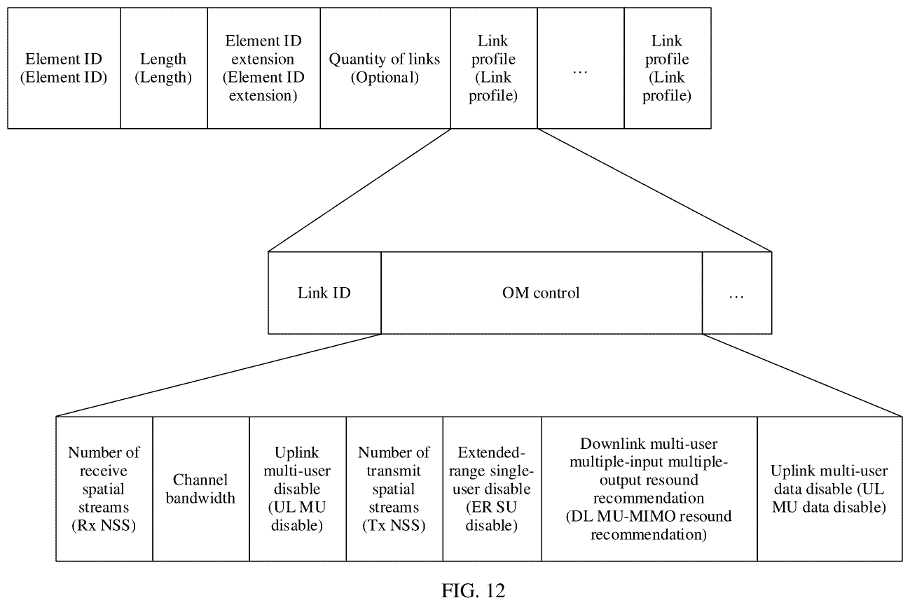

For example, a structure of a configuration information #A unit may be shown in FIG. 8 or FIG. 9. For details, refer to the foregoing description. Details are not described herein again. Alternatively, the structure of the configuration information #A unit may be shown in FIG. 12.

Different from FIG. 8 or FIG. 9, the structure shown in FIG. 12 may include an operating mode (OM) control (OM control) field. For example, the OM control field may include but is not limited to an Rx NSS, a channel bandwidth field, an uplink (UL) multi-user (MU) disable (UL MU disable) field, a Tx NSS, an extended-range (ER) single-user disable (ER SU disable) field, a downlink (DL) multi-user multiple-input multiple-output (MU-MIMO) resound recommendation (DL MU-MIMO resound recommendation) field, and an uplink multi-user data disable (UL MU data disable) field.

It should be understood that the frame structure shown in FIG. 12 is merely an example for description. This is not limited in this embodiment of this application. For example, the frame structure may include more fields or fewer fields.

In addition, optionally, the configuration information #A may be carried at a physical layer, for example, carried in a signaling field of a physical layer preamble; or may be carried in MAC, for example, carried in a MAC header. For example, the configuration information #A is carried in the MAC. For example, a new control information type may be defined in an HE variant of an HT control field to carry the configuration information #A. It is assumed that the newly defined control information may carry a maximum of 26 bits, that is, the 26 bits may carry the configuration information #A. A frame structure of the newly defined control information may be designed as any one of the following.

Design 1: The frame structure may include a spatial stream (SS) allocation field and a link ID field.

The SS allocation field may carry allocation information of a spatial stream. In other words, the SS allocation field may carry allocation information of all spatial streams allocated to all links.

The link ID field may carry identification information of the link, that is, indicate the links to which the spatial streams are allocated.

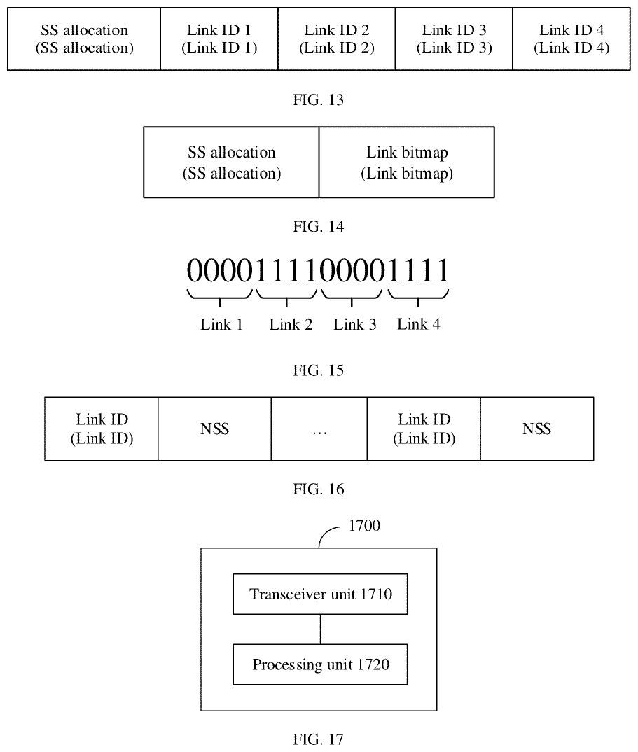

FIG. 13 shows a possible frame structure. As shown in FIG. 13, the frame structure may include the SS allocation field and the link ID field.

The link ID field may include, for example, a link ID 1, a link ID 2, a link ID 3, and a link ID 4. It should be understood that FIG. 13 is merely an example for description. Based on different communication cases, the link ID field may include more or fewer link IDs.

It is assumed that there are a maximum of 16 spatial streams, and the spatial streams may be allocated to a maximum of four links. After calculation, there may be at least 576 allocation schemes. Therefore, 10 bits may be used to distinguish each allocation scheme. As shown in FIG. 13, the link ID 1, the link ID 2, the link ID 3, and the link ID 4 are identification information of links, that is, indicate the links to which the spatial streams are allocated. If a number of allocated links is less than 4, a special link identifier, for example, a dummy link identifier (dummy link ID), may also indicate that link indication is complete. For example, when the special link identifier is all 1s (that is, a value of each bit is 1), it indicates that the link indication is complete.

Design 2: The frame structure may include an SS allocation field and a link bitmap field.

The SS allocation field may carry allocation information of a spatial stream. In other words, the SS allocation field may carry allocation information of all spatial streams allocated to all links.

The link bitmap field may indicate the links to which the spatial streams are allocated.

FIG. 14 shows a possible frame structure. As shown in FIG. 14, the frame structure may include the SS allocation field and the link bitmap field. The frame structure shown in FIG. 14 is used as an example, and 16 bits may indicate allocation of spatial streams. Each of the 16 bits may indicate a link to which a corresponding spatial stream is allocated. For example, if a value of a corresponding bit is the same as a value of a previous bit, it indicates that the spatial stream is allocated to a same link; otherwise, the spatial stream is allocated to a next link.

For example, as shown in FIG. 15, a value of the SS allocation field is 0000110101000001111. It is assumed that it starts from a link 1, it indicates that a link indicated by each of first four bits is allocated to the link 1 (that is, a value of each of the first four bits is 0), a link indicated by each of the following four bits is allocated to a link 2 (that is, a value of each of the following four bits is 1), a link indicated by each of the following four bits is allocated to a link 3 (that is, a value of each of the following four bits is 0), and a link indicated by each of last four bits is allocated to a link 4 (that is, a value of each of the following four bits is 0).

The link bitmap field may indicate the link to which the spatial stream is allocated. It is assumed that a total quantity of links is 8, and the SS allocation field allocates all spatial streams to four links (as shown in FIG. 15). In this case, a length of the link bitmap field is 8 bits, and values of four bits are 1, which correspond to four links to which the spatial streams are allocated. It is assumed that values of only three bits are 1, it indicates that only a number of spatial streams indicated by first three consecutive segments of 0s or 1s in the SS allocation field are allocated to a link.

Design 3: The frame structure may include a link ID field and an NSS field.

The link ID field and the NSS field respectively indicate an identifier of a link and a number of allocated spatial streams.

FIG. 16 shows a possible frame structure. As shown in FIG. 16, the frame structure may include a plurality of link ID fields and the NSS field. When each of the link ID field and the NSS field is 4 bits, three links may be indicated in total. When each of the link ID field and the NSS field is 3 bits, four links may be indicated in total.

It should be understood that FIG. 13 to FIG. 16 are merely examples for description, and the frame structures shown in FIG. 13 to FIG. 16 are not limited in this embodiment of this application.

In this embodiment of this application, quantities of spatial streams of a plurality of links may be indicated at a time by using one piece of signaling, and the plurality of links do not need to be separately enabled. A number of spatial streams of each link is indicated one by one by using each link. This further reduces energy consumption. In addition, when the configuration frame is sent, the relatively optimal configuration or the optimal configuration may be selected. Therefore, not only the RF chain resource can be flexibly configured, and the RF chain can be properly used, but also it can be more power save.

It should be understood that message names and field names in the foregoing embodiments are merely used to distinguish between different functions, and do not limit the protection scope of embodiments of this application. Names indicating a same function in a future protocol all fall within the protection scope of embodiments of this application.

It should be further understood that the frame structures in some of the foregoing embodiments, as shown in FIG. 4, FIG. 5, FIG. 8, FIG. 9, and FIG. 12 to FIG. 16, are all examples for description, and any variation that belongs to the frame structures falls within the protection scope of embodiments of this application.

Based on the foregoing technical solution, the multi-link device (for example, the first device) can dynamically switch between two communication modes. For example, in some cases, for example, when a communication requirement is low, the first device may send a first message to the second device, where the first message requests to switch to a second communication mode. For another example, in some cases, for example, when the communication requirement is high, the first device may send the first message to the second device, where the first message requests to switch to a first communication mode. Therefore, when the communication service requirement is low, an unnecessary link may be disabled, and a number of spatial streams of the link may be reduced, to achieve an power save objective.

In addition, based on the foregoing technical solution, after entering the second communication mode (or a multi-link power save mode), the multi-link device (for example, the first device) may dynamically switch between a plurality of configurations (for example, between the second configuration and the first configuration, between the second configuration and the third configuration, or between the second configuration and the fourth configuration). This achieves a balance between a high rate and low power consumption, and achieves an objective of using a most appropriate configuration for communication.

Embodiments described in this specification may be independent solutions, or may be combined based on internal logic. All these solutions fall within the protection scope of this application. For example, in the method 600, a solution in which the first device restores the second configuration from the first configuration may be used in a solution in which the first device restores the second configuration from the third configuration, or may be used in a solution in which the first device restores the second configuration from the fourth configuration. For another example, a solution of the configuration information #A may be used by the first device to indicate the first configuration, the second configuration, or the third configuration to the second device, or used by the second device to indicate the fourth configuration to the first device. For another example, the solution shown in the method 1100 may be used independently, or may be used in combination with the method 300, the method 600, or the method 700. For another example, a solution in which the first device determines whether sending of data by the second device ends may be used independently, or may be used in combination with the solution in the method 300, the method 600, the method 700, or the method 1100.

It may be understood that the methods and operations implemented by the first device in the foregoing method embodiments may alternatively be implemented by a component (for example, a chip or a circuit) applicable to the first device, and the methods and operations implemented by the second device in the foregoing method embodiments may alternatively be implemented by a component (for example, a chip or a circuit) applicable to the second device.

The methods according to embodiments of this application are described above in detail with reference to FIG. 3 and FIG. 16. The apparatuses provided in embodiments of this application are described below in detail with reference to FIG. 17 to FIG. 20. It should be understood that description of apparatus embodiments corresponds to the description of the method embodiments. Therefore, for content that is not described in detail, refer to the foregoing method embodiments. For brevity, details are not described herein again.

The foregoing mainly describes the solutions provided in embodiments of this application from the perspective of interaction between devices. It can be understood that, to implement the foregoing functions, the devices, for example, the first device and the second device, include corresponding hardware structures and/or software modules for performing the functions. A person skilled in the art may be aware that, with reference to the examples described in embodiments disclosed in this specification, units and algorithm steps can be implemented by hardware or a combination of hardware and computer software in this application. Whether a function is performed by hardware or hardware driven by computer software depends on particular applications and design constraints of the technical solutions. A person skilled in the art may use different methods to implement the described functions for each particular application, but it should not be considered that the implementation goes beyond the protection scope of this application.

In embodiments of this application, the first device and the second device may be divided into functional modules based on the foregoing method examples. For example, the functional modules may be obtained through division based on corresponding functions, or two or more functions may be integrated into one processing module. The integrated module may be implemented in a form of hardware, or may be implemented in a form of a software function module. It should be noted that, in embodiments of this application, division into the modules is an example, and is merely logical function division. In an actual implementation, another feasible division manner may be available. An example in which each functional module is obtained through division based on a corresponding function is used below for description.

FIG. 17 is a schematic block diagram of a communication apparatus according to an embodiment of this application. The communication apparatus 1700 includes a transceiver unit 1710 and a processing unit 1720. The transceiver unit 1710 may implement a corresponding communication function, and the processing unit 1710 is configured to perform data processing. The transceiver unit 1710 may also be referred to as a communication interface or a communication unit.

Optionally, the communication apparatus 1700 may further include a storage unit. The storage unit may be configured to store instructions and/or data. The processing unit 1720 may read the instructions and/or data in the storage unit, to enable the communication apparatus to implement the foregoing method embodiments.

The communication apparatus 1700 may be configured to perform the actions performed by the first device in the foregoing method embodiments. In this case, the communication apparatus 1700 may be the first device or a component that can be configured in the first device. The transceiver unit 1710 is configured to perform receiving/sending-related operations on the first device side in the foregoing method embodiments. The processing unit 1720 is configured to perform processing-related operations on the first device side in the foregoing method embodiments.

Alternatively, the communication apparatus 1700 may be configured to perform the actions performed by the second device in the foregoing method embodiments. In this case, the communication apparatus 1700 may be the second device or a component that can be configured in the second device. The transceiver unit 1710 is configured to perform receiving/sending-related operations on the second device side in the foregoing method embodiments. The processing unit 1720 is configured to perform processing-related operations on the second device side in the foregoing method embodiments.

In a design, the communication apparatus 1700 is configured to perform the actions performed by the first device in the foregoing method embodiments. The transceiver unit 1710 is configured to send a first message to a second device, where the first message is used to notify the second device that the communication apparatus 1700 switches a communication mode. The switching a communication mode includes switching from a first communication mode to a second communication mode, or the switching a communication mode includes switching from the second communication mode to the first communication mode. The processing unit 1720 is configured to configure the communication apparatus 1700 to switch from the first communication mode to the second communication mode, or switch from the second communication mode to the first communication mode. The first communication mode includes a first configuration, and the second communication mode includes the first configuration and a second configuration. Under the first configuration, the first device can perform communication on N links, under the second configuration, the first device can perform communication on M links, Mis an integer greater than 1 or equal to 1, N is an integer greater than 2 or equal to 2, and N is greater than M.

In an example, the transceiver unit 1710 is further configured to receive a second message from the second device, where the second message is a response message or an acknowledgment message for the first message; and the processing unit 1720 is further configured to switch the communication mode.

In still another example, when the communication apparatus 1700 is in the second communication mode, the transceiver unit 1710 is further configured to perform communication by using the second configuration; or the transceiver unit 1720 is further configured to switch between the first configuration and the second configuration for communication.

In still another example, when the communication apparatus 1700 is in the second communication mode, the transceiver unit 1710 is further configured to perform communication by using the second configuration; the transceiver unit 1710 is further configured to receive a radio frame from the second device; the processing unit 1720 is further configured to switch to the first configuration; and the transceiver unit 1710 is further configured to transmit data to the second device by using the first configuration.

In still another example, when the communication apparatus 1700 is in the second communication mode, the transceiver unit 1710 is further configured to perform communication by using the second configuration; the transceiver unit 1710 is further configured to receive information about a third configuration from the second device; the processing unit 1720 is further configured to switch to the third configuration based on the information about the third configuration; and the transceiver unit 1710 is further configured to transmit data to the second device by using the third configuration.

In still another example, when the communication apparatus 1700 is in the second communication mode, the transceiver unit 1710 is further configured to perform communication by using the second configuration; the transceiver unit 1710 is further configured to receive information about a third configuration from the second device; the processing unit 1720 is further configured to switch to a fourth configuration based on the information about the third configuration, where the fourth configuration is determined based on the third configuration; and the transceiver unit 1710 transmits data to the second device by using the fourth configuration.

In still another example, the transceiver unit 1710 is further configured to send a third message to the second device, where the third message indicates, to the second device, information about a configuration used for transmitting data.

In still another example, after the data transmission ends, the transceiver unit 1710 is further configured to perform communication by using the second configuration.

In still another example, that the transceiver unit 1710 is configured to transmit data to the second device by using the first configuration includes: The transceiver unit 1710 is configured to receive a data frame from the second device on T links. T is an integer greater than 1 or equal to 1; the data frame on each of the T links includes a more data field, the more data field in the data frame on a link indicates whether data transmission on the corresponding link ends, and the processing unit 1720 is further configured to determine, based on the more data field on each link, whether the data transmission ends; or the data frame includes a multi-link more data field, the multi-link more data field indicates whether data transmission on the T links ends, and the processing unit 1720 is further configured to determine, based on the multi-link more data field, whether the data transmission ends.

In still another example, the transceiver unit 1710 is further configured to send indication information to one station of the second device. The indication information includes information about the first configuration or information about the second configuration, and the indication information indicates configuration information of each station on one or more links of the communication apparatus 1700.

In still another example, the first message includes one or more of the following: first information, information about a communication link, and second information; the first information indicates whether the communication apparatus 1700 switches from the first communication mode to the second communication mode; the information about the communication link indicates a communication link obtained after the communication mode is switched; and the second information indicates whether the communication apparatus 1700 can switch between the first configuration and the second configuration when the communication apparatus 1700 is in the second communication mode.

In still another example, the information about the first configuration or the information about the second configuration includes one or more pieces of the following information: an identifier of a link, a number of spatial streams of the link, bandwidth of the link, whether to support uplink multi-user transmission, and whether to support an extended-range transmission mode.

The communication apparatus 1700 may implement steps or procedures performed by the first device in FIG. 3 to FIG. 16 according to embodiments of this application. The communication apparatus 1700 may include units configured to perform the methods performed by the first device in FIG. 3 to FIG. 16. In addition, the units in the communication apparatus 1700 and the foregoing other operations and/or functions are separately used to implement corresponding procedures in FIG. 3 to FIG. 16.

For example, when the communication apparatus 1700 is configured to perform the method 300 in FIG. 3, the transceiver unit 1710 may be configured to perform step 310 in the method 300, and the processing unit 1720 may be configured to perform step 3201 or 3202 in the method 300.

For another example, when the communication apparatus 1700 is configured to perform the method 600 in FIG. 6, the transceiver unit 1710 may be configured to perform steps 610, 620, 630, 601, 602, and 605 in the method 600, and the processing unit 1720 may be configured to perform step 603 in the method 600.

For another example, when the communication apparatus 1700 is configured to perform the method 700 in FIG. 7, the transceiver unit 1710 may be configured to perform steps 710, 720, and 730 in the method 700.

For another example, when the communication apparatus 1700 is configured to perform the method 1000 in FIG. 10, the transceiver unit 1710 may be configured to perform steps 1010, 1020, 1040, and 1060 in the method 1000, and the processing unit 1720 may be configured to perform steps 1030 and 1050 in the method 1000.

For another example, when the communication apparatus 1700 is configured to perform the method 1100 in FIG. 11, the transceiver unit 1710 may be configured to perform steps 1110 and 1120 in the method 1100.

It should be understood that a process in which the units perform the foregoing corresponding steps is described in detail in the foregoing method embodiments. For brevity, details are not described herein again.

In another design, the communication apparatus 1700 is configured to perform the actions performed by the second device in the embodiment shown in FIG. 3. The transceiver unit 1710 is configured to receive a first message from a first device, where the first message is used to notify the communication apparatus 1700 that the first device switches a communication mode. The switching a communication mode includes: switching from the first communication mode to the second communication mode, or switching from the second communication mode to the first communication mode. The processing unit 1720 is configured to determine a communication mode to which the first device switches. The first communication mode includes a first configuration, and the second communication mode includes the first configuration and a second configuration. Under the first configuration, the communication apparatus 1700 can communicate with the first device on N links, under the second configuration, the communication apparatus 1700 can communicate with the first device on M links, M is an integer greater than 1 or equal to 1, N is an integer greater than 2 or equal to 2, and N is greater than M.

For example, the transceiver unit 1710 is further configured to communicate with the first device by using a transmission parameter supported by the communication mode to which the first device switches.

In an example, the transceiver unit 1710 is further configured to send a second message to the first device, where the second message is a response message or an acknowledgment message for the first message.

In still another example, the processing unit 1720 is further configured to determine that the communication mode to which the first device switches is the second communication mode; the transceiver unit 1710 is further configured to send a radio frame to the first device by using a first parameter, where the first parameter is a parameter supported by the second configuration; and the transceiver unit 1710 is further configured to: receive a third message from the first device, and transmit data to the first device by using a second parameter, where the second parameter is a parameter supported by the first configuration, and the third message indicates the second device to transmit the data by using the first configuration.

In still another example, the processing unit 1720 is further configured to determine that the communication mode to which the first device switches is the second communication mode; the transceiver unit 1710 is further configured to send information about a third configuration to the first device by using a first parameter; and the transceiver unit 1710 is further configured to: receive a third message from the first device, and transmit data to the first device by using a third parameter, where the third parameter is a parameter supported by the third configuration, and the third message indicates the second device to transmit the data by using the third configuration.

In still another example, the processing unit 1720 is further configured to determine that the communication mode to which the first device switches is the second communication mode; the transceiver unit 1710 is further configured to send information about a third configuration to the first device by using a first parameter; the transceiver unit 1710 is further configured to receive a third message from the first device, where the third message includes information about a fourth configuration; and the transceiver unit 1710 is further configured to transmit data to the first device by using a fourth parameter, where the fourth parameter is a parameter supported by the fourth configuration, and the fourth configuration is determined based on the third configuration.

In still another example, the transceiver unit 1710 is further configured to receive indication information from the first device, where the indication information includes information about the first configuration or information about the second configuration; and the processing unit 1720 is further configured to determine configuration information of each station on one or more links of the first device based on the indication information.

In still another example, the first message includes one or more of the following: first information, information about a communication link, and second information; the first information indicates whether the communication mode of the communication apparatus 1700 is switched from the first communication mode to the second communication mode; the information about the communication link indicates a communication link obtained after the communication mode is switched; and the second information indicates whether the communication apparatus 1700 can switch between the first configuration and the second configuration when the communication apparatus 1700 is in the second communication mode.

In still another example, the information about the first configuration or the information about the second configuration includes one or more pieces of the following information: an identifier of a link, a number of spatial streams of the link, bandwidth of the link, whether to support uplink multi-user transmission, and whether to support an extended-range transmission mode.

The communication apparatus 1700 may implement steps or procedures performed by the second device in FIG. 3 to FIG. 16 according to embodiments of this application. The communication apparatus 1700 may include units configured to perform the methods performed by the second device in FIG. 3 to FIG. 16. In addition, the units in the communication apparatus 1700 and the foregoing other operations and/or functions are separately used to implement corresponding procedures in FIG. 3 to FIG. 16.

For example, when the communication apparatus 1700 is configured to perform the method 300 in FIG. 3, the transceiver unit 1710 may be configured to perform step 310 in the method 300.

For another example, when the communication apparatus 1700 is configured to perform the method 600 in FIG. 6, the transceiver unit 1710 may be configured to perform steps 610, 620, 630, 601, 602, and 605 in the method 600.

For another example, when the communication apparatus 1700 is configured to perform the method 700 in FIG. 7, the transceiver unit 1710 may be configured to perform steps 710, 720, and 730 in the method 600.

For another example, when the communication apparatus 1700 is configured to perform the method 1000 in FIG. 10, the transceiver unit 1710 may be configured to perform steps 1010, 1020, 1040, and 1060 in the method 1000.

For another example, when the communication apparatus 1700 is configured to perform the method 1100 in FIG. 11, the transceiver unit 1710 may be configured to perform steps 1110 and 1120 in the method 1100.

It should be understood that a process in which the units perform the foregoing corresponding steps is described in detail in the foregoing method embodiments. For brevity, details are not described herein again.

The processing unit 1720 in the foregoing embodiment may be implemented by at least one processor or a processor-related circuit. The transceiver unit 1710 may be implemented by a transceiver or a transceiver-related circuit. The transceiver unit 1710 may also be referred to as a communication unit or a communication interface. The storage unit may be implemented by using at least one memory.

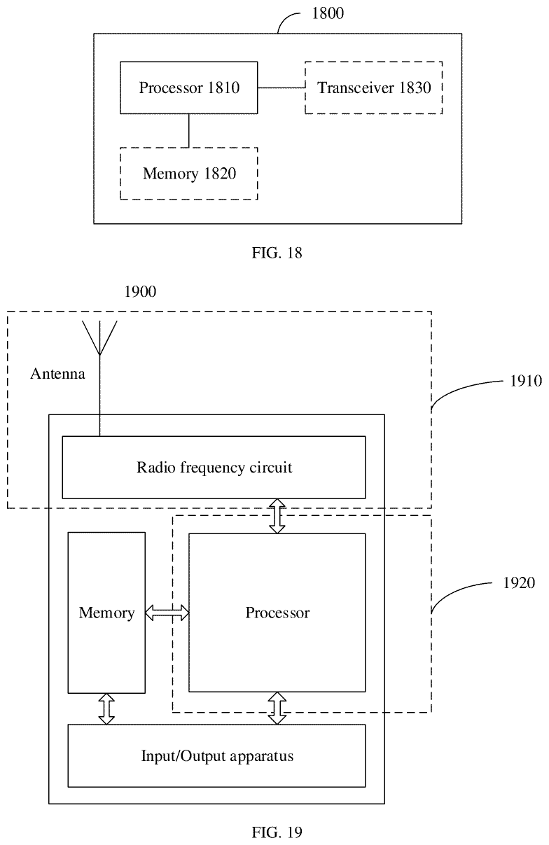

As shown in FIG. 18, an embodiment of this application further provides a communication apparatus 1800. The communication apparatus 1800 includes a processor 1810.

The processor 1810 is coupled to a memory 1820. The memory 1820 is configured to store a computer program or instructions and/or data. The processor 1810 is configured to execute the computer program or instructions and/or data stored in the memory 1820, so that the methods in the foregoing method embodiments are executed.

Optionally, the communication apparatus 1800 includes one or more processors 1810.

In an example, as shown in FIG. 18, the communication apparatus 1800 may further include the memory 1820.

Optionally, the communication apparatus 1800 may include one or more memories 1820.

In an example, the memory 1820 may be integrated with the processor 1810, or disposed separately from the processor 1810.

In an example, as shown in FIG. 18, the communication apparatus 1800 may further include a transceiver 1830, and the transceiver 1830 is configured to receive and/or send a signal. For example, the processor 1810 is configured to control the transceiver 1830 to receive and/or send a signal.

In a solution, the communication apparatus 1800 is configured to perform the operations performed by the first device in the foregoing method embodiments.

For example, the processor 1810 is configured to perform a processing-related operation performed by the first device in the foregoing method embodiments, and the transceiver 1830 is configured to perform a receiving/sending-related operation performed by the first device in the foregoing method embodiments.

In another solution, the communication apparatus 1800 is configured to perform the operations performed by the second device in the foregoing method embodiments.

For example, the processor 1810 is configured to perform a processing-related operation performed by the second device in the foregoing method embodiments, and the transceiver 1830 is configured to perform a receiving/sending-related operation performed by the second device in the foregoing method embodiments.

An embodiment of this application further provides a communication apparatus 1900. The communication apparatus 1900 may be a first device or a chip. The communication apparatus 1900 may be configured to perform an operation performed by the first device in the foregoing method embodiments.

When the communication apparatus 1900 is the first device, the communication apparatus 1900 may be, for example, a multi-link device such as a multi-link station device. FIG. 19 is a simplified schematic diagram of a structure of the first device. As shown in FIG. 19, the first device includes a processor, a memory, a radio frequency circuit, an antenna, and an input/output apparatus. The processor is mainly configured to: process a communication protocol and communication data, control the first device, execute a software program, process data of the software program, and the like. The memory is mainly configured to store the software program and the data. The radio frequency circuit is mainly configured to: perform conversion between a baseband signal and a radio frequency signal, and process the radio frequency signal. The antenna is mainly configured to send and receive a radio frequency signal in a form of an electromagnetic wave. The input/output apparatus, for example, a touchscreen, a display, a keyboard, or the like is mainly configured to: receive data input by a user, and output data to the user. It should be noted that some types of first devices may have no input/output apparatus.

When needing to send data, after performing baseband processing on the to-be-sent data, the processor outputs a baseband signal to the radio frequency circuit. The radio frequency circuit performs radio frequency processing on the baseband signal, and then sends a radio frequency signal to outside in the form of the electromagnetic wave by using the antenna. When data is sent to the first device, the radio frequency circuit receives a radio frequency signal by using the antenna, converts the radio frequency signal into a baseband signal, and outputs the baseband signal to the processor. The processor converts the baseband signal into data, and processes the data. For ease of description, FIG. 19 shows only one memory and one processor. In an actual first device product, there may be one or more processors and one or more memories. The memory may also be referred to as a storage medium, a storage device, or the like. The memory may be disposed independent of the processor, or may be integrated with the processor. This is not limited in embodiments of this application.

In this embodiment of this application, the antenna that has sending and receiving functions and the radio frequency circuit may be considered as a transceiver unit of the first device, and the processor that has a processing function may be considered as a processing unit of the first device.

As shown in FIG. 19, the first device includes a transceiver unit 1910 and a processing unit 1920. The transceiver unit 1910 may also be referred to as a transceiver, a transceiver machine, a transceiver apparatus, or the like. The processing unit 1920 may also be referred to as a processor, a processing board, a processing module, a processing apparatus, or the like.

Optionally, a component that is in the transceiver unit 1910 and that is configured to implement a receiving function may be considered as a receiving unit, and a component that is in the transceiver unit 1910 and that is configured to implement a sending function may be considered as a sending unit. In other words, the transceiver unit 1910 includes the receiving unit and the sending unit. The transceiver unit may also be sometimes referred to as a transceiver machine, a transceiver, a transceiver circuit, or the like. The receiving unit may also be sometimes referred to as a receiver machine, a receiver, a receiver circuit, or the like. The sending unit may also be sometimes referred to as a transmitter machine, a transmitter, a transmitter circuit, or the like.

For example, in an implementation, the processing unit 1920 is configured to perform a processing action on the first device side in FIG. 3. For example, the processing unit 1920 is configured to perform a processing step in step 3201 or step 3202 in FIG. 3, and the transceiver unit 1910 is configured to perform receiving and sending operations in step 310 in FIG. 3.

For another example, in an implementation, the processing unit 1920 is configured to perform a processing step in step 603 in FIG. 6, and the transceiver unit 1910 is configured to perform receiving and sending operations in steps 610, 620, 630, 601, 602, and 605 in FIG. 6.

For another example, in an implementation, the transceiver unit 1910 is configured to perform receiving and sending operations in steps 710, 720, and 730 in FIG. 7.

For another example, in an implementation, the processing unit 1920 is configured to perform processing steps in steps 1030 and 1050 in FIG. 10, and the transceiver unit 1910 is configured to perform receiving and sending operations in steps 1010, 1020, 1040, and 1060 in FIG. 11.

For another example, in an implementation, the transceiver unit 1910 is configured to perform receiving and sending operations in steps 1110 and 1120 in FIG. 11.

It should be understood that FIG. 19 is merely an example instead of a limitation. The first device including the transceiver unit and the processing unit may not depend on the structure shown in FIG. 19.

When the communication apparatus 1900 is a chip, the chip includes a transceiver unit and a processing unit. The transceiver unit may be an input/output circuit or a communication interface. The processing unit may be a processor, a microprocessor, or an integrated circuit that is integrated on the chip. When the communication apparatus 1900 is a chip system or a processing system, a device in which the communication apparatus 1900 is installed can implement the methods and the functions in embodiments of this application. For example, the processing unit 1920 may be a chip system or a processing circuit in a processing system, to control a device in which the chip system or the processing system is installed. The processing unit 1920 may further be coupled to a storage unit, and invoke instructions in the storage unit, so that the device can implement the methods and the functions in embodiments of this application. The transceiver unit 1910 may be an input/output circuit in the chip system or the processing system, to output information processed by the chip system, or input to-be-processed data or signaling information into the chip system for processing. The communication apparatus 1900 may be, for example, a Wi-Fi chip. Therefore, an apparatus in which the chip is installed can communicate with another device by using the 802.11 protocol.

An embodiment of this application further provides a communication apparatus 2000. The communication apparatus 2000 may be a second device or a chip. The communication apparatus 2000 may be configured to perform an operation performed by the second device in the foregoing method embodiments.

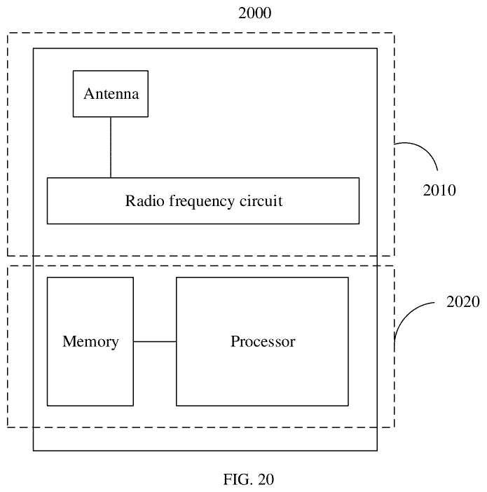

When the communication apparatus 2000 is the second device, the communication apparatus 2000 may be, for example, a multi-link device such as a multi-link access point device. FIG. 20 is a simplified schematic diagram of a structure of the second device. The second device includes a part 2010 and a part 2020. The part 2010 is mainly configured to send and receive a radio frequency signal and perform conversion between the radio frequency signal and a baseband signal. The part 2020 is mainly configured to perform baseband processing, control the second device, and the like. The part 2010 may be usually referred to as a transceiver unit, a transceiver machine, a transceiver circuit, a transceiver, or the like. The part 2020 is usually a control center of the second device, may be usually referred to as a processing unit, and is configured to control the second device to perform a processing operation on the network device side in the foregoing method embodiments.

The transceiver unit in the part 2010 may also be referred to as a transceiver or the like. The transceiver unit includes an antenna and a radio frequency circuit, where the radio frequency circuit is mainly configured to perform radio frequency processing. Optionally, a component that is in the part 2010 and that is configured to implement a receiving function may be considered as a receiving unit, and a component that is configured to implement a sending function may be considered as a sending unit. In other words, the part 2010 includes the receiving unit and the sending unit. The receiving unit may also be referred to as a receiver machine, a receiver, a receiver circuit, or the like, and the sending unit may be referred to as a transmitter, a transmitter circuit, or the like.

The part 2020 may include one or more boards, and each board may include one or more processors and one or more memories. The processor is configured to read and execute a program in the memory to implement a baseband processing function and control the second device. If there are a plurality of boards, the boards may be interconnected to enhance a processing capability. In an optional implementation, a plurality of boards may share one or more processors, a plurality of boards share one or more memories, or a plurality of boards simultaneously share one or more processors.

For example, in an implementation, the transceiver unit in the part 2010 is configured to perform receiving/sending-related steps performed by the second device in the embodiment shown in FIG. 3, and the part 2020 is configured to perform processing-related steps performed by the second device in the embodiment shown in FIG. 3.

For another example, in an implementation, the transceiver unit in the part 2010 is configured to perform receiving/sending-related steps performed by the second device in the embodiment shown in FIG. 6, and the part 2020 is configured to perform processing-related steps performed by the second device in the embodiment shown in FIG. 6.

For another example, in an implementation, the transceiver unit in the part 2010 is configured to perform receiving/sending-related steps performed by the second device in the embodiment shown in FIG. 7, and the part 2020 is configured to perform processing-related steps performed by the second device in the embodiment shown in FIG. 7.

For another example, in an implementation, the transceiver unit in the part 2010 is configured to perform receiving/sending-related steps performed by the second device in the embodiment shown in FIG. 10, and the part 2020 is configured to perform processing-related steps performed by the second device in the embodiment shown in FIG. 10.

For another example, in an implementation, the transceiver unit in the part 2010 is configured to perform receiving/sending-related steps performed by the second device in the embodiment shown in FIG. 11, and the part 2020 is configured to perform processing-related steps performed by the second device in the embodiment shown in FIG. 11.

It should be understood that FIG. 20 is merely an example instead of a limitation. The network device including the transceiver unit and the processing unit may not depend on the structure shown in FIG. 20.

When the communication apparatus 2000 is a chip, the chip includes a transceiver unit and a processing unit. The transceiver unit may be an input/output circuit or a communication interface. The processing unit is a processor, a microprocessor, or an integrated circuit integrated on the chip. The communication apparatus 2000 may alternatively be a chip system or a processing system, a device in which the communication apparatus 2000 is installed can implement the methods and the functions in embodiments of this application. For example, the processing unit 2020 may be a chip system or a processing circuit in a processing system, to control a device in which the chip system or the processing system is installed. The processing unit 2020 may further be coupled to a storage unit, and invoke instructions in the storage unit, so that the device can implement the methods and the functions in embodiments of this application. The transceiver unit 2010 may be an input/output circuit in the chip system or the processing system, to output information processed by the chip system, or input to-be-processed data or signaling information into the chip system for processing. The communication apparatus 2000 may be, for example, a Wi-Fi chip. Therefore, an apparatus in which the chip is installed can communicate with another device by using the 802.11 protocol.

An embodiment of this application further provides a computer-readable storage medium. The computer-readable storage medium stores computer instructions used to implement the method performed by the first device or the method performed by the second device in the foregoing method embodiments.

For example, when the computer program is executed by a computer, the computer is enabled to implement the method performed by the first device or the method performed by the second device in the foregoing method embodiments.

An embodiment of this application further provides a computer program product including instructions. When the instructions are executed by a computer, the computer is enabled to implement the method performed by the first device or the method performed by the second device in the foregoing method embodiments.

An embodiment of this application further provides a communication system. The communication system includes the first device and the second device in the foregoing embodiments.

For explanations and beneficial effects of related content of any communication apparatus provided above, refer to a corresponding method embodiment provided above. Details are not described herein again.

It should be understood that, the processor mentioned in embodiments of this application may be a central processing unit (CPU), the processor may further be another general-purpose processor, a digital signal processor (DSP), an application-specific integrated circuit (ASIC), a field programmable gate array (FPGA), or another programmable logic device, a discrete gate, a transistor logic device, a discrete hardware component, or the like. The general-purpose processor may be a microprocessor, or the processor may be any conventional processor or the like.

It may be further understood that the memory mentioned in embodiments of this application may be a volatile memory or a non-volatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms in the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, it should be understood that the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In addition, function units in embodiments of this application may be integrated into one unit, or each of the units may exist alone physically, or two or more units are integrated into one unit.

All or some of foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like. For example, the usable medium may include but is not limited to any medium that can store program code, such as a USB flash drive, a removable hard disk, a read-only memory (ROM), a random access memory (RAM), a magnetic disk, or an optical disc.

The foregoing description is merely an example implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

1. A communication mode switching method, comprising:
receiving, by a second device, a first message from a first device, wherein the first message is used to notify the second device that the first device is switching a communication mode, and the switching the communication mode comprises: switching from a first communication mode to a second communication mode, or switching from the second communication mode to the first communication mode; and
determining, by the second device, the communication mode to which the first device switches,
wherein
the first communication mode comprises a first configuration,
the second communication mode comprises the first configuration and a second configuration,
under the first configuration, the first device can perform communication on N links,
under the second configuration, the first device can perform communication on M links,
M is an integer greater than 1 or equal to 1,
N is an integer greater than 2 or equal to 2, and
N is greater than M.

2. The communication mode switching method according to claim 1, further comprising:
in response to the second device determining that the communication mode to which the first device is switching is the second communication mode, sending, by the second device, a radio frame to the first device by using a first parameter, wherein the first parameter is a parameter supported by the second configuration;
receiving, by the second device, a third message from the first device, wherein the third message indicates the second device to transmit data by using the first configuration; and
transmitting, by the second device, the data to the first device by using a second parameter, wherein the second parameter is a parameter supported by the first configuration.

3. The communication mode switching method according to claim 1, further comprising:
in response to the second device determining that the communication mode to which the first device is switching is the second communication mode, sending, by the second device, information about a third configuration to the first device by using a first parameter, wherein the first parameter is a parameter supported by the second configuration;
receiving, by the second device, a third message from the first device, wherein the third message indicates the second device to transmit data by using the third configuration; and
transmitting, by the second device, the data to the first device by using a third parameter, wherein the third parameter is a parameter supported by the third configuration.

4. The communication mode switching method according to claim 1, further comprising:
in response to the second device determining that the communication mode to which the first device is switching is the second communication mode, sending, by the second device, information about a third configuration to the first device by using a first parameter, wherein the first parameter is a parameter supported by the second configuration;
receiving, by the second device, a third message from the first device, wherein the third message comprises information about a fourth configuration; and
transmitting, by the second device, data to the first device by using a fourth parameter, wherein the fourth parameter is a parameter supported by the fourth configuration, and the fourth configuration is determined based on the third configuration.

5. The communication mode switching method according to claim 1, further comprising:
receiving, by the second device, indication information from the first device, wherein the indication information comprises information about the first configuration or information about the second configuration; and
determining, by the second device, configuration information of each station on one or more links of the first device based on the indication information.

6. The communication mode switching method according to claim 1, wherein
the first message comprises one or more of first information, information about a communication link, or second information;
the first information indicates whether the first device is switching from the first communication mode to the second communication mode;
the information about the communication link indicates a communication link obtained after the communication mode is switched; and
the second information indicates whether the first device is to switch between the first configuration and the second configuration while the first device is in the second communication mode.

7. The communication mode switching method according to claim 6, wherein
the information about the first configuration or the information about the second configuration comprises one or more pieces of the following information:
an identifier of a link,
a number of spatial streams of the link,
a bandwidth of the link,
whether to support uplink multi-user transmission, or
whether to support an extended-range transmission mode.

8. The communication mode switching method according to claim 1, further comprising:
after data transmission between the first device and the second device by using the first configuration ends, switching, by the first device, to communication by using the second configuration.

9. A configuration indication method applied to multi-link communication, comprising:
sending, by a first device, a configuration frame to a second device, wherein the configuration frame carries fifth configuration information, and the configuration frame indicates operating mode information of a plurality of links; and
receiving, by the first device, an acknowledgment frame from the second device, wherein the acknowledgment frame is an acknowledgment frame for the configuration frame.

10. The configuration indication method according to claim 9, further comprising:
after receiving the acknowledgment frame, transmitting, by the first device, data to the second device by using a fifth parameter, wherein the fifth parameter is a parameter supported by the fifth configuration information.

11. The configuration indication method according to claim 9, wherein the operating mode information comprises one or more of the following:
a number of spatial streams of a link,
a bandwidth of the link,
whether to support uplink multi-user transmission, or
whether to support an extended-range transmission mode.

12. The configuration indication method according to claim 9, wherein a frame structure of the fifth configuration information comprises a spatial stream (SS)_allocation field and a link identifier (ID) field, and the SS allocation field is used to carry allocation information of a spatial stream.

13. The configuration indication method according to claim 9, wherein a frame structure of the fifth configuration information comprises an SS allocation field and a link bitmap field, and the SS allocation field is used to carry allocation information of a spatial stream.

14. The configuration indication method according to claim 9, wherein a frame structure of the fifth configuration information comprises a link identifier (ID) field and a number of spatial streams (NSS) field, and the link ID field and the NSS field respectively indicate an identifier of a link and a number of allocated spatial streams.

15. A communication apparatus, comprising:
a processor; and
a memory having instructions stored thereon that, when executed by the processor, cause the communication apparatus to:
receive a first message from a first device, wherein the first message is used to notify the communication apparatus that the first device is switching a communication mode, and the switching the communication mode comprises: switching from a first communication mode to a second communication mode, or switching from the second communication mode to the first communication mode; and
determine the communication mode to which the first device switches, wherein
the first communication mode comprises a first configuration,
the second communication mode comprises the first configuration and a second configuration,
under the first configuration, the first device can perform communication on N links,
under the second configuration, the first device can perform communication on M links,
M is an integer greater than 1 or equal to 1,
N is an integer greater than 2 or equal to 2, and
N is greater than M.

16. The communication mode switching method according to claim 15, wherein the communication apparatus is further caused to:
in response to determining that the communication mode to which the first device is switching is the second communication mode, send a radio frame to the first device by using a first parameter, wherein the first parameter is a parameter supported by the second configuration;
receive a third message from the first device, wherein the third message indicates the communication apparatus to transmit data by using the first configuration; and
transmit, the data to the first device by using a second parameter, wherein the second parameter is a parameter supported by the first configuration.

17. The communication mode switching method according to claim 15, wherein the communication apparatus is further caused to:
in response to determining that the communication mode to which the first device is switching is the second communication mode, send information about a third configuration to the first device by using a first parameter, wherein the first parameter is a parameter supported by the second configuration;
receive a third message from the first device, wherein the third message indicates the communication apparatus to transmit data by using the third configuration; and
transmit the data to the first device by using a third parameter, wherein the third parameter is a parameter supported by the third configuration.

18. The communication mode switching method according to claim 15, wherein the communication apparatus is further caused to:
in response to determining that the communication mode to which the first device is switching is the second communication mode, send information about a third configuration to the first device by using a first parameter, wherein the first parameter is a parameter supported by the second configuration;
receive a third message from the first device, wherein the third message comprises information about a fourth configuration; and
transmit data to the first device by using a fourth parameter, wherein the fourth parameter is a parameter supported by the fourth configuration, and the fourth configuration is determined based on the third configuration.

19. The communication mode switching method according to claim 15, wherein the communication apparatus is further caused to:
receive indication information from the first device, wherein the indication information comprises information about the first configuration or information about the second configuration; and
determine configuration information of each station on one or more links of the first device based on the indication information.

20. The communication mode switching method according to claim 15, wherein
the first message comprises one or more of first information, information about a communication link, or second information;
the first information indicates whether the first device is switching from the first communication mode to the second communication mode;
the information about the communication link indicates a communication link obtained after the communication mode is switched; and
the second information indicates whether the first device is to switch between the first configuration and the second configuration while the first device is in the second communication mode.
